(19) United States
(12) Patent Application Publication
(10) Pub. No.: US 2006/0036012 A1
(43) Pub. Date: Feb. 16, 2006

(54) Process for producing a wollastonite containing polyester and products and articles produced therefrom

(76) Inventors: Richard Allen Hayes, Brentwood, TN (US); Kenneth B. Atwood, Hendersonville, TN (US); Steven M. Hansen, Vienna, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/199,927

(22) Filed: Aug. 9, 2005

Related U.S. Application Data
(60) Provisional application No. 60/600,484, filed on Aug. 10, 2004.

(51) Int. Cl. C08K 3/34

(52) U.S. Cl. 524/445

(57) ABSTRACT

The present invention provides a process for producing a polyester from a polyester composition comprising at least about 1 wt. % wollastonite, based on the total weight of the polyester composition, wherein the wollastonite is added at a temperature of about 240° C. or less. The present invention further provides a process for producing a polyester from a polyester composition comprising at least about 1 wt. % wollastonite, based on the total weight of the polyester composition, and about 0.01 wt. % other filler, based on total weight of the polyester composition, wherein the wollastonite is added at a temperature of about 240° C. or less. The invention is further directed to polyester products produced by said process and the shaped articles formed therefrom.

This application claims the benefit of U.S. Provisional Application No. 60/600,484, filed Aug. 10, 2004, which is incorporated by reference herein for all purposes as if fully set forth.

### FIELD OF THE INVENTION

The present invention relates to a process for producing a wollastonite containing polyester. The present invention further relates to a process for producing a polyester containing wollastonite and at least one other filler. The present invention further relates to products and articles produced therefrom.

### BACKGROUND

Reinforcing fillers are commonly incorporated into polymer compositions to improve the strength, thermal performance, and dimensional stability of the polymers produced from such compositions. This is especially true of engineering polymer compositions, which typically produce polymers that serve structural functions requiring such polymers to withstand heat and physical abuse. Reinforcing fillers, however, have relatively large particle sizes that typically cause the surface appearance of parts made from such compositions to be compromised.

It is known in the art that wollastonite reinforcing fillers can be added to a polyester composition. Wollastonite is a naturally occurring mineral chemically composed of mainly an acicular calcium silicate, and typically has nominal particle diameters of 1.8 microns or less and aspect ratios, which are determined by dividing the average particle length by the nominal particle diameter of 20:1 or more.

Generally, wollastonite reinforcing fillers are added through intensive melt mixing processes, such as melt extrusion. Typical melt extrusion processes are disclosed in, for example, U.S. Pat. No. 5,965,655 and WO 2004/020520. When intensive melt mixing processes are used, however, the wollastonite containing polyester compositions are caused to have an additional thermal history that tends to thermally destabilize the compositions. In addition, intensive melt extrusion processes can cause wollastonite particles to undergo breaking or shearing, which decreases the aspect ratios of the particles and leads to a decrease in strength, thermal performance and dimensional stability of the wollastonite containing polyester produced therefrom.

It is known in the art that wollastonite can be added during the polymerization of a polyester, wherein the mixing intensity typically used during such polymerization is much lower than the mixing intensity used during the melt extrusion process. For example, in U.S. Pat. No. 4,274,025, Nerurkar et. al. disclose a process for producing slot liners and closures from a polyester film containing 0.2 to 0.9% by weight of filler particles having a nominal particle size of 2 to 10 μm and a hardness of 2.5 to 7 on the moh scale. In JP 3258836, Hamano et. al. disclose the production of oriented polyester films containing wollastonite fillers, wherein the wollastonite fillers are added at a temperature of 250° C., which is during the polymerization of the polyester from terephthalic acid. It is known that terephthalic acid has limited solubility in ethylene glycol at temperatures below 250° C.

It is further known in the art that a polyester produced via a terephthalic acid process will generally contain approximately twice as much diethylene glycol thermal degradation product than a polyester prepared via a dimethyl terephthalate process.

The present invention provides a process for preparing a wollastonite containing polyester having improved strength, heat deformation temperatures, and dimensional stability from a polyester composition, wherein at least about 1 weight percent wollastonite, based on the total weight of the polyester composition, is added to the polyester composition at a temperature of about 240° C. or less, and is polymerized with the polymerizable components of the polyester composition.

### SUMMARY OF THE INVENTION

One aspect of the present invention is a process for producing a polyester having enhanced resin thermal stability from a polyester composition containing at least about 0.1 weight percent wollastonite reinforcing filler, wherein the wollastonite is added at temperature of about 240° C. or less, wherein the wollastonite is further contacted with the polymerizable components of the polyester composition and the polymerizable components are polymerized. Preferably, the wollastonite is added at a temperature of about 230° C. or less. The wollastonite reinforcing fillers preferably have an aspect ratio of at least about 5:1, and more preferably of at least about 10:1. The wollastonite reinforcing fillers preferably have a median particle diameter of about 20 microns or less, more preferably of about 10 microns or less, and most preferably of from about 3 microns to about 10 microns. The polyester composition contains at least about 1 weight percent wollastonite reinforcing filler, based on the total weight of the polyester composition; preferably from about 1 to about 30 weight percent; and more preferably from about 2.5 to about 20 weight percent.

Another aspect of the present invention is a process for producing a polyester having enhanced resin thermal stability from a polyester composition containing at least about 0.1 weight percent wollastonite reinforcing filler, wherein the wollastonite is added at temperature of about 240° C. or less, wherein the wollastonite is further contacted with the polymerizable components of the polyester composition and the polymerizable components are polymerized. Preferably, the wollastonite is added at a temperature of about 230° C. or less. The wollastonite reinforcing fillers preferably have an aspect ratio of at least about 5:1, and more preferably of at least about 10:1. The wollastonite reinforcing fillers preferably have a median particle diameter of about 20 microns or less, more preferably of about 10 microns or less, and most preferably of from about 3 microns to about 10 microns. The polyester composition contains at least about 1 weight percent wollastonite reinforcing filler, based on the total weight of the polyester composition; preferably from about 1 to about 30 weight percent; and more preferably from about 2.5 to about 20 weight percent. The polyester composition contains at least about 0.01 weight percent other filler, based on the total weight of the polyester composition; preferably from about 0.1 to about 20 weight percent, more preferably from about 1 to about 15 weight percent. Preferably, the other fillers are carbon black. The carbon black fillers preferably have a DBP value of at least about 150 cc/100 grams; and more preferably of at least about 220 cc/100 grams. Preferably, the carbon black and wollastonite containing polyester compositions have electrical properties.

A further aspect of the present invention includes producing a shaped article from the polyester produced in accordance with the process of the present invention. The shaped articles include, but are not limited to, for example, films, sheets, filaments, molded articles, and thermoformed articles.

A further aspect of the present invention includes producing monofilaments having enhanced abrasion resistance and strength from the wollastonite containing polyesters produced in accordance with the process of the present invention.

### DETAILED DESCRIPTION OF THE INVENTION

The features and advantages of the present invention will be more readily understood by those of ordinary skill in the art upon reading the following detailed description. It is to be appreciated that certain features of the invention that are, for clarity reasons, described above and below in the context of separate embodiments, may also be combined to form a single embodiment. Conversely, various features of the invention that are, for brevity reasons, described in the context of a single embodiment, may be combined so as to form sub-combinations thereof.

Moreover, unless specifically stated otherwise herein, references made in the singular may also include the plural (for example, “a” and “an” may refer to either one, or one or more). In addition, unless specifically stated otherwise herein, the minimum and maximum values of any of the variously stated numerical ranges used herein are only approximations that are understood to be preceded by the word “about” so that slight variations above and below the stated ranges can be used to achieve substantially the same results as those values within the stated ranges. Moreover, each of the variously stated ranges are intended to be continuous so as to include every value between the stated minimum and maximum value of each of the ranges.

Further, when an amount, concentration, or other value or parameter is given as a list of upper preferable values and lower preferable values, this is to be understood as specifically disclosing all ranges formed from any pair of an upper preferred value and a lower preferred value, regardless of whether ranges are separately disclosed

All patents, patent applications and publications referred to herein are incorporated by reference.

The present invention provides a processes for producing a polyester from a polyester composition comprising at least one diester based on a terephthalic acid, optionally at least one other dicarboxylic acid, at least one glycol, at least about 1 wt. % wollastonite, optionally at least one polyfunctional branching agent, and optionally at least one other filler, wherein the process comprises adding the wollastonite at a temperature of about 240° C. or less; contacting the wollastonite and optional other filler with at least one polymerizable component of the polyester composition; and polymerizing the polymerizable components. The polyester composition comprises a diester based on a terephthalic acid, optionally another dicarboxylic acid, a glycol, a wollastonite reinforcing filler, and, optionally, a polyfunctional branching agent.

Diesters based on terephthalic acid include, but are not limited to, lower alkyl esters of terephthalic acid having 10 to 50 carbons; and bisglycolate esters of terephthalic acid. For example, diesters based on terephthalic acid include, but are not limited to, dimethyl terephthalate; diethyl terephthalate; bis(2-hydroxyethyl)terephthalate; bis(3-hydroxypropyl)terephthalate; bis(4-hydroxybutyl)terephthalate; and mixtures thereof. Preferably, the polyester composition contains from about 1 to about 100 mole percent diester based on terephthalic acid, based on 100 mole percent of total diester based on terephthalic acid and optional other dicarboxylic acid; and more preferably from about 50 to about 100 mole percent.

The optional other dicarboxylic acid includes, but is not limited to, unsubstituted, substituted, linear, and branched dicarboxylic acids; lower alkyl esters of dicarboxylic acids having from 2 carbons to 36 carbons; and bisglycolate esters of dicarboxylic acids with the exception of terephthalic acid and derivatives thereof. For example, the optional other dicarboxylic acids include, but are not limited to, isophthalic acid; dimethyl isophthalate; 2,6-naphthalene dicarboxylic acid; dimethyl-2,6-naphthalate; 2,7-naphthalene dicarboxylic acid; dimethyl-2,7-naphthalate; metal salts of 5-sulfoisophthalic acid; sodium dimethyl-5-sulfoisophthalate; lithium dimethyl-5-sulfoisophthalate; 3,4′-diphenyl ether dicarboxylic acid; dimethyl-3,4′diphenyl ether dicarboxylate; 4,4′-diphenyl ether dicarboxylic acid; dimethyl-4,4′-diphenyl ether dicarboxylate; 3,4′-diphenyl sulfide dicarboxylic acid; dimethyl-3,4′-diphenyl sulfide dicarboxylate; 4,4′-diphenyl sulfide dicarboxylic acid; dimethyl-4,4′-diphenyl sulfide dicarboxylate; 3,4′-diphenyl sulfone dicarboxylic acid; dimethyl-3,4′-diphenyl sulfone dicarboxylate; 4,4′-diphenyl sulfone dicarboxylic acid; dimethyl-4,4′-diphenyl sulfone dicarboxylate; 3,4′-benzophenonedicarboxylic acid; dimethyl-3,4′-benzophenonedicarboxylate; 4,4′-benzophenonedicarboxylic acid; dimethyl-4,4′-benzophenonedicarboxylate; 1,4-naphthalene dicarboxylic acid; dimethyl-1,4-naphthalate; 4,4′-methylene bis(benzoic acid); dimethyl-4,4′-methylenebis(benzoate); bis(2-hydroxyethyl)isophthalate; bis(3-hydroxypropyl)isophthalate; bis(4-hydroxybutyl)isophthalate; oxalic acid; dimethyl oxalate; malonic acid; dimethyl malonate; succinic acid; dimethyl succinate; methylsuccinc acid; glutaric acid; dimethyl glutarate; 2-methylglutaric acid; 3-methylglutaric acid; adipic acid; dimethyl adipate; 3-methyladipic acid; 2,2,5,5-tetramethylhexanedioic acid; pimelic acid; suberic acid; azelaic acid; dimethyl azelate; sebacic acid; 1,11-undecanedicarboxylic acid; 1,10-decanedicarboxylic acid; undecanedioic acid; 1,12-dodecanedicarboxylic acid; hexadecanedioic acid; docosanedioic acid; tetracosanedioic acid; dimer acid; bis(2-hydroxyethyl)glutarate; bis(3-hydroxypropyl)glutarate; bis(4-hydroxybutyl)glutarate); and mixtures thereof and derived therefrom.

Preferably, the optional other dicarboxylic acid is an aromatic dicarboxylic acid. Preferably, the aromatic dicarboxylic acid is selected from isophthalic acid; dimethyl isophthalate; bis(2-hydroxyethyl)isophthalate; bis(3-hydroxypropyl)isophthalate; bis(4-hydroxybutyl)isophthalate; 2,6-naphthalene dicarboxylic acid; dimethyl-2,6-naphthalate; and mixtures thereof and derived therefrom. More preferably, the optional other dicarboxylic acid is an aromatic diester or bis(glycolate) ester. This should not be considered limiting as essentially any other dicarboxylic acid known in the art may find utility within the present invention.

The polyester composition contains from about 0 to about 99 mole percent optional other dicarboxylic acid, based on 100 mole percent total diester based on terephthalic acid and optional other dicarboxylic acid; and preferably from about 0 to about 50 mole percent.

The glycol includes, but is not limited to, unsubstituted, substituted, straight chain, branched, cyclic aliphatic, aliphatic-aromatic and aromatic diols having from 2 to 36 carbon atoms. For example, the glycol includes, but is not limited to, ethylene glycol; 1,3-propanediol; 1,4-butanediol; 1,6-hexanediol; 1,8-octanediol; 1,10-decanediol; 1,12-dodecanediol; 1,14-tetradecanediol; 1,16-hexadecanediol; dimer diol; 4,8-bis(hydroxymethyl)-tricyclo[5.2.1.0/2.6]decane; 1,4-cyclohexanedimethanol; isosorbide; di(ethylene glycol); tri(ethylene glycol); poly(alkylene ether)glycols preferably having a molecular weight in the range of from about 500 to about 4000; poly(ethylene glycol); poly(1,3-propylene glycol); poly(1,4-butylene glycol); (polytetrahydrofuran); poly(pentamethylene glycol); poly(hexamethylene glycol); poly(hepthamethylene glycol); poly(ethylene glycol)-block-poly(propylene glycol)-block-poly(ethylene glycol); 4,4′-isopropylidenediphenol ethoxylate (Bisphenol A ethoxylate); 4,4′-(1-phenylethylidene)bisphenol ethoxylate (Bisphenol AP ethoxylate); 4,4′-ethylidenebisphenol ethoxylate (Bisphenol E ethoxylate); bis(4-hydroxyphenyl)methane ethoxylate (Bisphenol F ethoxylate); 4,4′-(1,3-phenylenediisopropylidene)bisphenol ethoxylate (Bisphenol M ethoxylate); 4,4′-(1,4-phenylenediisopropylidene)bisphenol ethoxylate (Bisphenol P ethoxylate); 4,4′sulfonyldiphenol ethoxylate (Bisphenol S ethoxylate); 4,4′-cyclohexylidenebisphenol ethoxylate (Bisphenol Z ethoxylate); and mixtures thereof and derived therefrom. This should not be considered limiting as essentially any glycol known in the art may find use in the present invention. Preferably, the glycol is ethylene glycol; 1,3-propanediol; 1,4-butanediol; 1,4-cyclohexanedimethanol; poly(alkylene ether)glycol; or mixtures thereof.

The optional polyfunctional branching agent includes, but is not limited to, any polyfunctional material having three or more carboxylic acid functions; three or more hydroxy functions; and mixture thereof. For example, polyfunctional branching agents include, but are not limited to, 1,2,4-benzenetricarboxylic acid (trimellitic acid); trimethyl-1,2,4-benzenetricarboxylate; 1,2,4-benzenetricarboxylic anhydride (trimellitic anhydride); 1,3,5-benzenetricarboxylic acid; 1,2,4,5-benzenetetracarboxylic acid (pyromellitic acid); 1,2,4,5-benzenetetracarboxylic dianhydride (pyromellitic anhydride); 3,3′,4,4′-benzophenonetetracarboxylic dianhydride; 1,4,5,8-naphthalenetetracarboxylic dianhydride; citric acid; tetrahydrofuran-2,3,4,5-tetracarboxylic acid; 1,3,5-cyclohexanetricarboxylic acid; pentaerythritol; glycerol; 2-(hydroxymethyl)-1,3-propanediol; 2,2-bis(hydroxymethyl)propionic acid; and mixtures thereof and derived therefrom. This should not be considered limiting as essentially any polyfunctional material having three or more carboxylic acid or hydroxyl functions may find use within the present invention. The optional polyfunctional branching agent is preferably included when polyesters having a higher resin melt viscosity is desired for specific enduses. Examples of such enduses include, but are not limited to, melt extrusion coatings; melt blown films or containers; and foam. Preferably, the polyester compositions of the present invention include from about 0 to 1.0 mole percent polyfunctional branching agent, based on 100 mole percent total diester based on terephthalic acid and optional other dicarboxylic acid.

Wollastonite includes, but is not limited to, minerals comprising primarily acicular calcium silicate. Wollastonite is also known as calcium meta silicate. Wollastonite is available, for example, from NYCO Minerals, Inc. under the tradenames Nyglos® MFH18 (which reportedly has a median particle diameter of 1.8 microns and an aspect ratio of about 5:100), Nyglos® 4 (which reportedly has a median particle diameter of 4 microns, an aspect ratio of about 11:1, and a N² BET surface area of 2.2 m²/g), Nyglos® 8 (which reportedly has a median particle diameter of 8 microns, an aspect ratio of about 19:1, and a N² BET surface area of 1.2 m²/g); and from R. T. Vanderbilt Company under the tradename Vansil® HR325 (which reportedly has a median particle diameter of 2.3 microns, an aspect ratio of about 12:1, and a N² BET surface area of 3.7 m²/g).

The wollastonite used in accordance with the present invention preferably has an aspect ratio of at least about 5:1, and more preferably of at least about 10:1. Preferably, the wollastonite has a median particle diameter of about 20 microns or less, more preferably about 10 microns or less, and most preferably of from about 3 to about 10 microns.

The polyester composition preferably contains at least about 1 weight percent wollastonite, based on the total weight of the polyester composition; more preferably from about 1 to about 30 weight percent; and most preferably from about 2.5 to about 20 weight percent.

The polyester compositions of the present invention may further be optionally filled with inorganic, organic and/or clay fillers. Such fillers include, but are not limited to, for example, carbon black; wood flour; gypsum; talc; mica; montmorillonite minerals; chalk; diatomaceous earth; sand; gravel; crushed rock; bauxite; limestone; sandstone; aerogels; xerogels; microspheres; porous ceramic spheres; gypsum dihydrate; calcium aluminate; magnesium carbonate; ceramic materials; pozzolamic materials; zirconium compounds; xonotlite (a crystalline calcium silicate gel); perlite; vermiculite; hydrated or unhydrated hydraulic cement particles; pumice; perlite; zeolites; clay fillers, including natural and synthetic clays, as well as, treated and untreated clays, such as, for example, organoclays and clays that have been surface treated with silanes and stearic acid to enhance polyester matrix adhesion, smectite clays, montmorillonite clays, magnesium aluminum silicate, kaolin, bentonite clays, hectorite clays, and mixtures thereof; silicon oxide; calcium terephthalate; aluminum oxide; titanium dioxide; iron oxides; calcium phosphate; barium sulfate; sodium carbonate; magnesium sulfate; aluminum sulfate; magnesium carbonate; barium carbonate; calcium oxide; magnesium oxide; aluminum hydroxide; calcium sulfate; barium sulfate; lithium fluoride; polymer particles; powdered metals; pulp powder; cellulose; starch; chemically modified starch; thermoplastic starch; lignin powder; wheat; chitin; chitosan; keratin; gluten; nut shell flour; wood flour; corn cob flour; calcium carbonate; calcium hydroxide; glass beads; hollow glass beads; sea gel; cork; seeds; gelatins; saw dust; agar-based materials; reinforcing agents, such as glass fibers, cellulose fibers, and natural fibers, such as, for example, sisal, hemp, cotton, wool, wood, flax, abaca, sisal, ramie, and bagasse; carbon fibers; graphite fibers; silica fibers; ceramic fibers; metal fibers; stainless steel fibers; and recycled paper fibers, for example, from repulping operations. A person of ordinary skill in the art is familiar with other acceptable fillers.

Fillers may tend to increase Young's modulus; improve dead-fold properties; improve rigidity of the film, coating, laminate or molded article; decrease costs; and reduce the tendency of the film, coating, or laminate to block or self-adhere during processing or use. Fillers have also been found to produce plastic articles that have many of the qualities of paper, such as texture and feel, as disclosed by, for example, Miyazaki et. al. in U.S. Pat. No. 4,578,296. The fillers can be added before, after, and/or any stage during polymerization. This should not be considered limiting as essentially any filler in the art can be added to the polyester compositions produced in accordance with the present invention.

The clay fillers may be further treated with organic materials, such as surfactants, to make them organophilic. Commercial examples of usable clay fillers include Gelwhite® MAS 100, which is a white smectite clay (magnesium aluminum silicate) produced by the Southern Clay Company; Claytone® 2000, which is an organophilic smectite clay produced by the Southern Clay Company; Gelwhite® L, which is a montmorillonite clay from a white bentonite clay produced by the Southern Clay Company; Cloisite® 30 B, which is an organophilic natural montmorillonite clay with bis(2-hydroxyethyl)methyl tallow quarternary ammonium chloride salt produced by the Southern Clay Company; Cloisite® Na, which is a natural montmorillonite clay produced by the Southern Clay Company; Garamite® 1958, which is a mixture of minerals produced by the Southern Clay Company; Laponite® RDS, which is a synthetic layered silicate with an inorganic polyphosphate peptiser produced by the Southern Clay Company; Laponite® RD, which is a synthetic colloidal clay produced by the Southern Clay Company; Nanomer®, which comprises montmorillonite minerals treated with compatibilizing agents, and is produced by the Nanocor Company; Nanomer® 1.24TL, which comprises montmorillonite minerals surface treated with amino acids, and is produce by the Nanocor Company; “P Series” Nanomer®, surface modified montmorillonite minerals produced by the Nanocor Company; Polymer Grade (PG) Montmorillonite PGW, which is a high purity aluminosilicate mineral, sometimes referred to as a phyllosilicate, produced by the Nanocor Company; Polymer Grade (PG) Montmorillonite PGA, which is a high purity aluminosilicate mineral, sometimes referred to as a phyllosilicate, produced by the Nanocor Company; Polymer Grade (PG) Montmorillonite PGV, which is a high purity aluminosilicate mineral, sometimes referred to as a phyllosilicate, produced by the Nanocor Company; Polymer Grade (PG) Montmorillonite PGN, a high purity aluminosilicate mineral, sometimes referred to as a phyllosilicate, produced by the Nanocor Company; and mixtures thereof. This should not be considered limiting as essentially any known clay filler can be used.

Some of the clay fillers of the present invention can exfoliate through the process to provide nanocomposites. This is especially true for layered silicate clays, such as, for example, smectite clays, magnesium aluminum silicate, bentonite clays, montmorillonite clays, and hectorite clays. As discussed above, such clays can be natural or synthetic, treated or not. This should not be considered limiting. The clay filler contained in the final filled polyester can have a broad range of particle sizes.

The filler utilized in the present invention can have a broad range of particle sizes. As one skilled within the art can appreciate, the size of the filler particles can be tailored to accommodate the manner in which the filled polyester composition is going to be used. The average diameter of the filler is generally preferred to be less than about 40 microns, and more preferably less than about 20 microns. However, this should not be considered limiting as the filler may include particle sizes ranging up to 40 mesh (US Standard) or larger. A filler containing a mixture of particle sizes can also advantageously be used. For example, a calcium carbonate filler having average particle sizes of about 5 and 0.7 microns can provide better space filling of the filler in the polyester matrix. Use of two or more filler particle sizes allows for improved particle packing. Particle packing is the process of selecting two or more ranges of filler particle sizes in order that the spaces between a group of large particles are substantially occupied by a selected group of smaller filler particles. In general, particle packing will be increased when any given set of particles is mixed with another set of particles having a particle size that is at least about 2 times larger or smaller than the first group of particles. The particle packing density for a two-particle system will be maximized when the size ratio of the first set of particles is from about 3 to 10 times the size of the second set of particles. Similarly, three or more different sets of particles can be used to further increase the particle packing density. The optimal packing density depends on a number of factors, including, for example, the types and concentrations of the various components in the thermoplastic and solid filler phases; the film, coating or lamination process used; and the desired mechanical, thermal, and other performance properties of the final product being produced. Particle packing techniques are further disclosed by Andersen et. al. in U.S. Pat. No. 5,527,387. Filler concentrates containing a mixture of filler particle sizes based on the above particle packing techniques are commercially available from the Shulman Company under the tradename Papermatch®.

The filler can be added to the polymer of the present invention at any stage during the polymerization of the polymer or after the polymerization is completed. For example, the fillers can be added with the polyester monomers at the start of the polymerization process. For example, silica and titanium dioxide fillers are preferably added with the polyester monomers so that the fillers are adequately dispersed in the polyester matrix. Alternatively, the filler can be added at an intermediate stage of polymerization, for example, as the precondensate passes into the polymerization vessel. As yet a further alternative, the filler can be added after the polyester exits the polymerizer. For example, the polyester compositions produced by the processes of the present invention can be melt fed to an intensive mixing operation, such as a static mixer or a single- or twin-screw extruder, and compounded with the filler.

In yet a further alternative, polyester compositions of the present invention can be combined with the filler in a subsequent post polymerization process. Typically, such a process involves intensive mixing of the molten polyester with the filler. The intensive mixing can be provided by, for example, static mixers, Brabender mixers, single screw extruders, and twin screw extruders. In a typical process, the polyester is dried, and then mixed with the filler. Alternatively, the polyester and the filler are cofed through two different feeders. In an extrusion process, the polyester and filler are typically fed into the back feed section of the extruder. However, this should not be considered limiting as the polyester and filler can also be advantageously fed into two different locations on the extruder. For example, the polyester can be added in the back feed section of the extruder while the filler is fed (“side-stuffed”) in the front of the extruder near the die plate. The extruder temperature profile is set up to allow the polyester to melt under the processing conditions. The screw design will also provide stress and, in turn, heat, to the resin as it mixes the molten polyester with the filler. Processes for melt mixing fillers with polymers are further disclosed, for example, by Dohrer et. al. in U.S. Pat. No. 6,359,050. Alternatively, the filler can be blended with the polyester materials during the formation of the films and coatings of the present invention, as is further described below.

A particularly preferred filler of the present invention is carbon black. The addition of carbon black can provide enhanced UV stability and advantageous electrical properties, such as antistatic and conductivity properties. For the purpose of the present invention, the conductive carbon black fillers are defined by their structure, wherein dibutyl phthlate (DBP) absorption, which is determined via ASTM Method No. D2414-93, is used to define the carbon black structures. DBP has been related to the structure of carbon blacks within the art. Typically, high structure carbon blacks also have high surface areas, and ASTM Method No. D3037-81, which measures the nitrogen adsorption (BET) of carbon black, can be used to measure carbon black surface areas.

Preferably, the carbon black utilized in accordance with the present invention has a DBP absorption of at least about 150 cc/100 gm, and more preferably of at least about 220 cc/100 grams. Commercial examples of carbon blacks suitable for use in accordance with the present invention include, but are not limited to, Ketjenblack® EC 600 JD by Akzo Company; Ketjenblack® EC 300 J by Akzo Company; Black Pearls® 2000 by Cabot Corporation; Printex® XE-2 by Cabot Corporation; Conductex® 975 by Columbian Company; and Vulcan® XC-72 by Cabot Company. Ketjenblack® EC 600 JD reportedly has a DBP absorption of between 480 and 520 cc/100 gm and a nitrogen adsorption between 1250 and 1270 m²/g. Ketjenblack® EC 300 J reportedly has a DBP absorption of between 350 and 385 cc/100 gm and a nitrogen adsorption of 800 m²/g. Black Pearls® 2000 reportedly has a DBP absorption of 330 cc/100 gm and a nitrogen adsorption of between 1475 and 1635 m²/g. Printex® XE-2 reportedly has a DBP absorption of between 380 and 400 cc/100 gm and a nitrogen adsorption of 1300 m²/g. Conductex® 975 reportedly has a DBP absorption of 170 cc/100 gm and a nitrogen adsorption of 250 m²/g. Vulcan® XC-72 reportedly has a DBP absorption of between 178 and 192 cc/100 gm and a nitrogen adsorption of 245 m²/g.

An effective amount of carbon black is added to the polyester compositions of the present invention to accommodate the entire range of desired electrical properties, such as, for example, antistatic; static dissipating or moderately conductive; and conductive properties. Preferably, the polyester composition contains about 15 weight percent or less carbon black, based on total weight of the polyester composition; more preferably from about 0.5 to about 10 weight percent, and most preferably from about 1.0 to about 7 weight percent.

Carbon black can be added as either slurry of dry raw black in a suitable fluid, or as a dispersion in a suitable fluid. Preferably, the suitable fluid of the dispersion and/or slurry is selected from at least one of the glycols already described hereinabove.

The carbon black dispersions of the present invention are produced by subjecting, for example, a slurry of carbon black in glycol to intensive mixing and grinding. Suitable dispersing equipment includes, but is not limited to, ball mills; Epenbauch mixers; Kady high shear mills; sandmills, such as, for example, 3P Redhead sandmills; and attrition grinding apparatuses.

For example, a ball milling process can be used to produce a carbon black dispersion, wherein carbon black is added to the milling chamber containing a glycol, such as ethylene glycol, and ceramic or stainless steel balls, and the ball mill is subsequently rotated for an effective amount of time to produce the desired dispersion. Typically, the effective amount of time ranges from about 0.5 to 50 hours. If desired, the resulting dispersion may further be centrifuged to remove any large particles of carbon black or grinding media.

The amount of carbon black dispersed in the glycol depends on the exact structure and nature of the carbon black being incorporated therein. The maximum amount of carbon black contained in such dispersions is determined based on the maximum amount of carbon black that can be incorporated therein and still be homogeneously dispersed in the glycol via the above processes.

A dispersing agent can be incorporated into the carbon black dispersions to enhance the wetting of the carbon black particles by the glycol, as well as, help maintain the formation of stable dispersions. Suitable dispersing agents include, for example, polyvinylpyrrolidone; epoxidized polybutadiene; and sodium salt of sulfonated naphthalene and fatty acids. Typically, carbon black dispersions contain about 0.1 to 8 weight percent of dispersing agent, based on total weight of the dispersion (carbon black, dispersing agent, and glycol).

Preferably, in the process of the present invention carbon black is added during the initial stages of polyester polymerization. Carbon black, however, can be added at any polyester polymerization stage prior to the polyester achieving an inherent viscosity of above about 0.20 dL/gm. Carbon black can, for example, be added either at the monomer stage with the dicarboxylic acid or glycol, or to the initial (trans)esterification product (precondenstates) ranging from bis(glycolate) to polyester oligomers having degrees of polymerization (DP) of about 10 or less. The carbon black is, however, preferably added either with the glycol, or to the initial (trans)esterification product.

The polyesters of the present invention can be prepared by conventional polycondensation techniques. The polyesters produced, however, may vary somewhat based on the method of preparation used, particularly with regard to the amount of glycol present in the polymer.

Preferably, the polyesters of the present invention are produced through a melt polymerization method. In a melt polymerization method, the diester based on terephthalic acid, the other dicarboxylic acid (either as acids, esters, bisglycolates or mixtures thereof, the glycol, the wollastonite, the optional carbon black, and the optionally polyfunctional branching agent are combined in the presence of a catalyst at a high enough temperature to enable the monomers to combine to form esters and diesters, then oligomers, and finally polymers. The wollastonite reinforcing fillers are added at a temperature of about 240° C. or less to produce a polyester resin having enhanced thermal stability. Preferably, the wollastonite reinforcing fillers are added at a temperature of about 230° C. or less. The wollastonite is contacted with at least one polyemerizable component of the polyester composition and the polymerizable components are polymerized. At the end of the polymerization process, the polymeric product is in a molten state. Generally, the glycol is volatile and distills from the reactor as polymerization proceeds. A person of ordinary skill in the art is familiar with the procedures associated with melt polymerization methods.

The melt process conditions of the present invention, particularly the amount of monomers used, depend on the polymer desired. The amounts of glycol, diester based on terephthalic acid, dicarboxylic acid, wollastonite, optional carbon black, and optional branching agent are chosen so that the final polymeric product contains the desired amount of monomers. Preferably, equimolar amounts of monomers are derived from the glycol as are derived from diester based on terephthalic acid and dicarboxylic acid in combination. Depending on the volatility of some of the monomers, especially some of the glycol monomers, and variables, such as, for example, whether the reactor is sealed, i.e. under pressure; the ramp rate of the polymerization temperature; and the efficiency of the distillation columns used to synthesize the polymer, excess amounts of some of the monomers may have to be added at the beginning of the polymerization reaction, and subsequently removed by distillation as the reaction proceeds. This is particularly true of glycol.

A skilled practitioner can readily determine the amount of monomer that needs to be added to a particular reactor. Often, however, the amount added will be in the ranges set forth hereinbelow. Often, excess amounts of diester based on terephthalic acid, dicarboxylic acid, and glycol are desirably added at the beginning of the polymerization reaction, and then subsequently removed by either distillation, or other means of evaporation as the polymerization reaction proceeds. Preferably, glycol, such as, for example, ethylene glycol, 1,3-propanediol, and 1,4-butanediol is added in an amount that is 10 to 100% greater than the amount the final polymer is desired to contain. Preferably, ethylene glycol is added in an amount that is 40 to 100% greater than the amount the final polymer is desired to contain. Preferably, 1,3-propanediol and 1,4-butanediol are added in amounts that are 20 to 70% greater than the amount the final polymer is desired to contain. Other glycols are preferably added in an amount that is 0 to 100% greater than the amount the final polymer is desired to contain, wherein the amount added depends on the exact volatility of the other glycol.

As there are a large number of variables including, for example, the efficiency of the distillation columns and the recovery and recycle systems being utilized (if any), that can affect the amount of monomers lost during polymerization, the monomer amounts are recited as broad ranges and are only intended to be approximations. A person of ordinary skill in the art is readily able to determine the amount of each monomer that needs to be added to achieve a specific polymer.

In the process of the present invention, the monomers are polymerized at a temperature in the range of from about 200 to about 330° C., and more preferably from about 220 to about 295° C., wherein the monomers are added and gradually heated while being stirred to the polymerization temperature. A catalyst or catalyst mixture is either added with the monomers and/or added one or more times to the monomer mixture as it is heated. The catalyst that is used can be changed as the reaction proceeds. The exact conditions and catalysts depend on whether the diester based on terephthalic acid is polymerized as either a diester, such as dimethyl terephthalate, or a bis(glycolate)ester, such as bis(2-hydroxyethyl) terephthalate; and whether the dicarboxylic acid is polymerized as a true acid, a dimethyl ester, or a bisglycolate. The heating and stirring are continued for a sufficient amount of time and to a sufficient temperature to yield a molten polymer having a high enough molecular weight to enable fabricated products to be made. Generally, excess reactants are removed via distillation.

In accordance with the process of the present invention, the wollastonite reinforcing fillers are added to the polyester polymerization process at a temperature of about 240° C. or less, and preferably at a temperature of about 230° C. or less. While not intended to be limiting, the wollastonite is preferably added either with the monomers prior to the initial transesterification to form the bisglycolates, or after the initial transesterification process but prior to the polymerization process. Adding wollastonite to the polyester polymerization process at a temperature of under about 240° C., and preferably under about 230° C., produces a polyester having enhanced thermal stability.

Catalysts that can be used include, but are not limited to, salts of Li, Ca, Mg, Mn, Zn, Pb, Sb, Sn, Ge, and Ti, such as, for example, acetate salts and oxides, including glycol adducts and Ti alkoxides. The contemplated catalysts are generally known in the art, and therefore a person of ordinary skill in the art can readily select the specific catalyst, catalyst combinations, and/or sequence of catalysts that can be used in accordance with the present process.

The preferred catalyst and preferred conditions will differ depending on, for example, whether the diester based on terephthalic acid is polymerized as either a diester, such as dimethyl terephthalate, or as a bisglycolate, such as (2-hydroxyethyl) terephthalate; whether the dicarboxylic acid is polymerized as a free dicarboxylic acid, a dimethyl ester, or a bisglycolate; and the exact chemical identity of the glycol being used. This should not be considered limiting as essentially any catalyst system known in the art can be used.

The monomer composition of the polymer is chosen based on the specific end use of the end polymer, as well as, set of properties the end polymer is desired to have. As one skilled in the art can appreciate, the exact thermal properties of the end polymer can be a complex function of the exact chemical identity and amount of each component utilized in preparing the end polymer.

The melt condensation process set forth hereinabove can produce polymers having an inherent viscosity (IV), which is an indicator of molecular weight, suitable for many applications. In general, polyesters produced in accordance with the present invention having an IV of at least about 0.25 dL/g will possess the physical properties desired. More preferably, the IV will be at least about 0.35 dL/g, as measured on a 0.5% (weight/volume) solution of the polyester in a 50:50 (weight) solution of trifluoroacetic acid:dichloromethane solvent system at room temperature, and most preferably the IV will be at least about 0.50 dL/g. Although the aforementioned lVs are sufficient for some applications, higher lVs are desired for many other applications, such as, for example, films, bottles, sheets, and molding resins. The polymerization conditions can be adjusted to obtain lVs of up to at least about 0.5 dL/g, and desirably even higher than 0.65 dL/g. Further processing of the polyester can achieve IVs of 0.7, 0.8, 0.9, 1.0, 1.5, 2.0 dL/g and even higher.

Normally, the molecular weight of the polymer is not measured directly. Instead, the IV of the polymer in solution and/or the melt viscosity is used as an indicator of molecular weight. IVs are used as molecular weight indicators when samples within a polymer family, such as, for example, poly(ethylene terephthalate), poly(butylene terephthalate), etc. are compared. IVs are used as herein as molecular weight indicators.

Solid state polymerization can be used to achieve even higher IVs (molecular weights). A polymer that is made via melt polymerization can, after being extruded, cooled, and pelletized, be essentially noncrystalline. A noncrystalline polymer, however, can be made semicrystalline by heating the polymer to a temperature above the glass transition temperature (T_{g}) for an extended period of time, wherein crystallization is induced so that the polymer can then be heated to a higher temperature to raise the molecular weight.

Crystallization can also be induced in a polymer prior to solid state polymerization by treating the polymer with a relatively poor solvent for polyesters, wherein such solvents allow crystallization to occur by reducing the T_{g}. The solvent induced crystallization of polyesters is further described in U.S. Pat. No. 5,164,478 and U.S. Pat. No. 3,684,766.

A semicrystalline polymer is subjected to solid state polymerization by placing the pelletized or pulverized polymer into either a stream of inert gas, which is usually nitrogen, or under a vacuum of 1 Torr at a temperature that is elevated, but yet below the melting temperature of the polymer, for an extended period of time.

The polymers produced in accordance with the process of the present invention can further contain additives known in the art. Such additives include, but are not limited to, thermal stabilizers, such as, for example, phenolic antioxidants; secondary thermal stabilizers, such as, for example, thioethers and phosphites; UV absorbers, such as, for example, benzophenone- and benzotriazole-derivatives; and UV stabilizers, such as, for example, hindered amine light stabilizers (HALS). Such additives may further include, for example, plasticizers; processing aides; flow enhancing additives; lubricants; pigments; flame retardants; impact modifiers; nucleating agents to increase crystallinity; antiblocking agents, such as silica; and base buffers, such as sodium acetate, potassium acetate, and tetramethyl ammonium hydroxide, such as, for example is disclosed in U.S. Pat. No. 3,779,993, U.S. Pat. No. 4,340,519, U.S. Pat. No. 5,171,308, U.S. Pat. No. 5,171,309, and U.S. Pat. No. 5,219,646. Plasticizers can be added to the polyester compositions of the present invention to improve processing; improve final mechanical properties; or reduce rattle or rustle of the films, coatings and laminates produced therefrom. Specific examples of such plasticizers include, but are not limited to, soybean oil; epoxidized soybean oil; corn oil; caster oil; linseed oil; epoxidized linseed oil; mineral oil; alkyl phosphate esters; Tween®20; Tween® 40; Tween® 60; Tween® 80; Tween® 85; sorbitan monolaurate; sorbitan monooleate; sorbitan monopalmitate; sorbitan trioleate; sorbitan monostearate; citrate esters, such as, for example, trimethyl citrate, triethyl citrate (Citroflex® 2 by Morflex, Inc. Greensboro, N.C.), tributyl citrate (Citroflexe 4 by Morflex, Inc., Greensboro, N.C.), trioctyl citrate, acetyltri-n-butyl citrate (Citroflex® A-4 by Morflex, Inc., Greensboro, N.C.), acetyltriethyl citrate (Citroflex® A-2 by Morflex, Inc., Greensboro, N.C.), acetyltri-n-hexyl citrate (Citroflexe A-6 by Morflex, Inc., Greensboro, N.C.), and butyryltri-n-hexyl citrate (Citroflex® B-6 by Morflex, Inc., Greensboro, N.C.); tartarate esters, such as, for example, dimethyl tartarate, diethyl tartarate, dibutyl tartarate, and dioctyl tartarate; poly(ethylene glycol); derivatives of poly(ethylene glycol); paraffin; monoacyl carbohydrates, such as 6-O-sterylglucopyranoside, glyceryl monostearate, Myvaplex® 600 (concentrated glycerol monostearates), Nyvaplex® (concentrated glycerol monostearate that is a 90% minimum distilled monoglyceride produced from hydrogenated soybean oil and is composed primarily of stearic acid esters), Myvacet® (distilled acetylated monoglycerides of modified fats), Myvacet® 507 (48.5 to 51.5% acetylation), Myvacet® 707 (66.5 to 69.5% acetylation), Myvacet® 908, (minimum of 96% acetylation), and Myverol® (concentrated glyceryl monostearates); Acrawax®; N,N-ethylene bis-stearamide; N,N-ethylene bis-oleamide; dioctyl adipate; diisobutyl adipate; diethylene glycol dibenzoate; dipropylene glycol dibenzoate; polymeric plasticizers, such as poly(1,6-hexamethylene adipate), poly(ethylene adipate), Rucoflex®, and other compatible low molecular weight polymers; and mixtures thereof. This should not be considered limiting as essentially any additive known in the art can be added to the polymers of the present invention.

The polymers produced in accordance with the process of the present invention can also be blended with other polymeric materials. Examples of blendable polymeric materials include, but are not limited to, polyethylene; high density polyethylene; low density polyethylene; linear low density polyethylene; ultralow density polyethylene; polyolefins; poly(ethylene-co-glycidylmethacrylate); poly(ethylene-co-methyl (meth)acrylate-co-glycidyl acrylate); poly(ethylene-co-n-butyl acrylate-co-glycidyl acrylate); poly(ethylene-co-methyl acrylate); poly(ethylene-co-ethyl acrylate); poly(ethylene-co-butyl acrylate); poly(ethylene-co-(meth)acrylic acid); metal salts of poly(ethylene-co-(meth)acrylic acid); poly((meth)acrylates), such as, for example, poly(methyl methacrylate) and poly(ethyl methacrylate); poly(ethylene-co-carbon monoxide); poly(vinyl acetate); poly(ethylene-co-vinyl acetate); poly(vinyl alcohol); poly(ethylene-co-vinyl alcohol); polypropylene; polybutylene; polyesters; poly(ethylene terephthalate); poly(1,3-propylene terephthalate); poly(1,4-butylene terephthalate); PETG; poly(ethylene-co-1,4-cyclohexanedimethanol terephthalate); polyetheresters; poly(vinyl chloride); PVDC; poly(vinylidene chloride); polystyrene; syndiotactic polystyrene; poly(4-hydroxystyrene); novalacs; poly(cresols); polyamides; nylon; nylon 6; nylon 46; nylon 66; nylon 612; polycarbonates; poly(bisphenol A carbonate); polysulfides; poly(phenylene sulfide); polyethers; poly(2,6-dimethylphenylene oxide); polysulfones; sulfonated aliphatic-aromatic copolyesters, such as are sold by the DuPont Company under the tradename Biomax®; aliphatic-aromatic copolyesters, such as are sold by Eastman Chemical Company under the tradename Eastar Bio® (Eastar Bio® is chemically believed to be essentially poly(1,4-butylene adipate-co-terephthalate (55:45 molar)), by BASF Corporation under the tradename Ecoflex® (Ecoflex® is believed to be essentially poly(1,4-butylene terephthalate-co-adipate (50:50 molar) and may be chain-extended through the addition of hexamethylenediisocyanate), and by Ire Chemical Company under the tradename EnPol®; aliphatic polyesters, such as poly(1,4-butylene succinate), (Bionolle® 1001 by Showa High Polymer Company), poly(ethylene succinate), poly(1,4-butylene adipate-co-succinate) (Bionolle® 3001 by Showa High Polymer Company), and poly(1,4-butylene adipate) as, for example, is sold by the Ire Chemical Company under the tradename EnPol®, by the Showa High Polymer Company under the tradename Bionolle®, by the Mitsui Toatsu Company, by the Nippon Shokubai Company, by the Cheil Synthetics Company, by the Eastman Chemical Company, and by the Sunkyon Industries Company; poly(amide esters), such as, for example, are sold by the Bayer Company under the tradename Bak® (these materials are believed to include the constituents of adipic acid, 1,4-butanediol, and 6-aminocaproic acid); polycarbonates, such as, for example, poly(ethylene carbonate) that is sold by the PAC Polymers Company; poly(hydroxyalkanoates), such as poly(hydroxybutyrate)s, poly(hydroxyvalerate)s, poly(hydroxybutyrate-co-hydroxyvalerate)s, such as, for example are sold by the Monsanto Company under the tradename Biopol®, poly(lactide-co-glycolide-co-caprolactone), such as, for example, sold by the Mitsui Chemicals Company under the grade designations of H100J, S100, and T100, poly(caprolactone), such as, for example, is sold by the Union Carbide Company under the tradename Tone(R), by the Daicel Chemical Company, and the Solvay Company, and poly(lactide), such as, for example, is sold by the Cargill Dow Company under the tradename EcoPLA® and the Dianippon Company; and the copolymers and mixtures thereof.

Examples of blendable natural polymeric materials include, but are not limited to, starch; starch derivatives; modified starch; thermoplastic starch; cationic starch; anionic starch; starch esters, such as starch acetate; starch hydroxyethyl ether; alkyl starches; dextrins; amine starches; phosphate starches; dialdehyde starches; cellulose; cellulose derivatives; modified cellulose; cellulose esters, such as cellulose acetate, cellulose diacetate, cellulose priopionate, cellulose butyrate, cellulose valerate, cellulose triacetate, cellulose tripropionate, cellulose tributyrate, and cellulose mixed esters, such as cellulose acetate propionate and cellulose acetate butyrate; cellulose ethers, such as methylhydroxyethylcellulose, hydroxymethylethylcellulose, carboxymethylcellulose, methyl cellulose, ethylcellulose, hydroxyethycellulose, and hydroxyethylpropylcellulose; polysaccharides; alginic acid; alginates; phycocolloids; agar; gum arabic; guar gum; acaia gum; carrageenan gum; furcellaran gum; ghatti gum; psyllium gum; quince gum; tamarind gum; locust bean gum; gum karaya; xantahn gum; gum tragacanth; proteins Zein® (a prolamine derived from corn); collagen (extracted from animal connective tissue and bones), and derivatives thereof such as gelatin and glue; casein (the principle protein in cow milk); sunflower protein; egg protein; soybean protein, vegetable gelatins; gluten; and mixtures thereof. As is disclosed in U.S. Pat. No. 5,362,777, thermoplastic starch can be produced by, for example, mixing and heating native or modified starch with high boiling plasticizers, such as glycerin or sorbitol, in such a way that the starch has little or no crystallinity, a low T_{g}, and a low water content. This should not be taken as limiting as essentially any polymeric material known in the art can be blended with the polymers produced in accordance with the present invention.

The additives, plasticizers, and blendable polymeric materials can be added to the polymer of the present invention at any stage either during the polymerization of the polymer, or after polymerization is completed. For example, the additives, plasticizers, and blendable polymeric materials can be added with the monomers at the start of the polymerization process. Alternatively, the additives, plasticizers, and blendable polymeric materials can be added at an intermediate stage of polymerization, such as, for example, as the precondensate passes into the polymerization vessel. In a further alternative, the additives, plasticizers, and blendable polymeric materials can be added after the polyester exits the polymerizer. For example, the polyester and the additives, plasticizers, and polymeric materials can be melt fed to an intensive mixing operation, such as, for example, a static mixer or a single- or twin-screw extruder. As yet a further alternative, the polyester can be combined with the additives, plasticizers, and blendable polymeric materials in a subsequent post polymerization process. Typically, a post polymerization process involves intensive mixing of the molten polyester with the additives, plasticizers, and blendable polymeric materials, wherein the intensive mixing is provided by, for example, static mixers, Brabender mixers, and single- or twin-screw extruders. In a typical process, the polyester and the additives, plasticizers, and blendable polymeric materials can be dried, wherein the dried polyester can be mixed with the dried additives, plasticizers, and blendable polymeric materials. Alternatively, the polyester and the additives, plasticizers, and blendable polymeric materials can be cofed in an extruder through two different feeders. In an extrusion process, the polyester and the additives, plasticizers, and blendable polymeric materials are typically fed into the back feed section of the extruder. However, this should not be considered limiting as the polyester and the additives, plasticizers, and blendable polymeric materials can be advantageously fed into two different locations on the extruder. For example, the polyester can be fed into the back feed section of the extruder while the additives, plasticizers, and blendable polymeric materials are fed (“side-stuffed”) into the front of the extruder near the die plate. The extruder temperature profile is set up to allow the polyester to melt under the processing conditions. The screw design can also provide stress and, in turn, heat to the resin as the extruder mixes the molten polyester with the additives, plasticizers, and blendable polymeric materials. Alternatively, the additives, plasticizers, and blendable polymeric materials can be blended with the polyester during the formation of the films and coatings of the present invention, as described below.

As a further aspect of the present invention, the polyesters produced in accordance with the process of the present invention have been found to be useful in a wide variety of shaped articles. The wollastonite containing polyesters produced in accordance with the process of the present invention provide enhanced strength, abrasion resistance, and stiffness, as well as, other benefits to the shaped articles made from such polyesters. Such shaped articles include, but are not limited to, films; sheets; fibers; monofilaments; nonwoven structures; melt blown containers; molded parts; foamed parts; substrates having polymeric melt extrusion coatings; and substrates having polymeric solution coatings. This should not be considered limiting as the polyesters of the present invention can be used to make essentially any shaped article. The polyesters of the present invention can find utility in essentially any process known in the art for forming shaped articles.

A preferred aspect of the present invention relates to molded parts comprising the polyesters produced in accordance with the present process, the production of such molded parts, and the articles derived from such molded parts. The wollastonite containing polyesters produced in accordance with the process of the present invention provide enhanced strength, abrasion resistance, and stiffness, as well as, other benefits to the molded parts made therefrom.

The polyesters of the present invention can be molded into shaped articles through any process known in the art, such as, for example, melt forming or compression molding. Melt forming can be carried out by the usual methods for thermoplastics, such as, for example, injection molding; thermoforming; extrusion; blow molding; or any combinations thereof.

Compression molding can be performed by any process known in the art, such as, for example, hand molds; semiautomatic molds; and automatic molds. Three common types of mold designs include open flash, fully positive, and semipositive. In general, the polyester of the present invention can be used in the compression molding operation in essentially any form, such as a powder, pellet, or disc, and is preferably dried and heated. The heated polyester is then loaded into a mold, which, depending on the exact polyester composition being used is typically held at a temperature of between 150° and 300° C. The mold is then partially closed and pressure is exerted. The pressure is generally between 2000 to 5000 psi, but depends, for example, on the exact compression molding process being utilized, the exact polyester material, and the part being molded. The polyester is melted by the action of the heat and exerted pressure, and flows into the recesses of the mold to form the shaped molded article.

Injection molding is the most preferred process for molding the shaped articles of the present invention. Injection molding can be performed through any process known in the art. The polyester of the present invention can be in essentially any form, such as powder, pellet or disc. Pellet form is preferable for ease of conveyance. The polyester of the present invention is preferably dried prior to use in such molding operations. Generally, the polyester of the present invention is fed into the back end of an extruder, typically with an automatic feeder, such as a K-Tron® or Accurate® feeder. Other desired additives, plasticizers, and blendable polymeric materials, as already set forth hereinabove in a non-limiting list, can either be pre-compounded with the polyester of the present invention, or cofed to the extruder. The polyester is then melted in the extruder and conveyed to the end of the extruder. Typically, a hydraulic cylinder pushes the screw forward to inject the molten polyester resin composition into the mold. The mold is generally clamped together with pressure, and is generally at a temperature that allows the polyester to crystallize and set up. Because of the wide variation in possible polyesters, the mold temperature may vary over a wide range. Generally, the temperature of the mold is between about room temperature and 200° C. The mold can be heated by, for example, steam; hot water; gas; electricity (such as resistance heaters, band heaters, low-voltage heaters, and induction heaters); and hot oil. Typically, the mold temperature is selected so as to provide the shortest mold cycle times possible. For slow crystallizing materials, such as poly(ethylene terephthalate), electrical heaters or hot oil is typically desired. For rapidly crystallizing materials, such as poly(1,4-butylene terephthalate), steam heat may be sufficient. Once the molten polyester has solidified, the mold pressure is released, the mold is opened, and the molded part is ejected from the mold cavity, typically through the help of, for example, knockout pins; ejector pins; knockout plates; stripper rings; compressed air; and/or combinations thereof.

The wide variety of shaped articles that can be produced via a molding process, include, for example, discs; plaques; bushings; automotive parts, such as door handles and window cranks; electrical parts; electronic mechanical parts; electrochemical sensors; positive temperature coefficient devices; temperature sensors; semiconductive shields for conductor shields; electrothermal sensors; electrical shields; high permittivity devices; housing for electronic equipment; and containers and pipelines for flammable solids powders, liquids, and gases.

Molded parts made from polyesters containing low levels of carbon black in accordance with the present invention will find utility for laser marking for identification purposes. Moreover, as parts fashioned from the wollastonite containing polyesters of the present invention have acceptable surface properties, such parts are particularly useful as “appearance parts”, i.e. parts for which the surface appearance is important. In contrast, molded parts fashioned from polymers containing other commonly utilized reinforcing agents, such as glass fiber, typically have unacceptable or damaged surface properties. The surface properties of the molded parts produced in accordance with the present invention are acceptable regardless of whether the surface of the part is viewed directly, or coated with paint or another material, such as metal. Such molded parts include, but are not limited to, automotive body panels, such as, for example, fenders, fascia, hoods, tank flaps, rocker panels, spoilers, and other interior and exterior parts; interior automotive panels; automotive trim parts; appliance parts, such as, for example, handles, control panels, chassises (cases), washing machine tubs and exterior parts, interior and exterior refrigerator panels, and dishwasher front and interior panels; power tool housings, such as, for example, drills and saws; electronic cabinets and housings, such as, for example, personal computer housings, printer housings, peripheral housings, and server housings; exterior and interior panels for vehicles, such as, for example, trains, tractors, lawn mower decks, trucks, snowmobiles, aircraft, and ships; decorative interior panels for buildings; furniture such as, for example, office and/or home chairs and tables; and telephones and other telephone equipment. Such parts can be painted or unpainted. Automotive body panels are an especially challenging application as the materials out of which such panels are made preferably have a smooth and reproducible surface appearance; are able to withstand temperatures as high as about 200° C. for up to 30 minutes so that the panels are able to pass through E-coat and paint ovens without being significantly distorted; and be tough enough to resist denting or other mechanical damage from minor impacts.

The carbon black contained in the polyesters of the present invention enable molded parts made from such carbon black containing polyesters to dissipate the electrical charges that are formed on the molded part as it is being electrostatically painted, thereby providing an even coating of paint on the entire surface of the molded part. Electrostatically painting a substrate is desired because paint waste and emissions, as compared to non-electrostatic painting processes, are reduced. Electrostatic paint coating processes enable relatively large parts to be consistently painted without color differences over the surface of the part. A significant advantage of the polyesters produced in accordance with the process of the present invention is the ability of such polyesters to be electrostatically painted while maintaining a majority of the physical properties attributed to the low carbon loadings of such polyesters.

A preferred aspect of the present invention relates to films comprising the wollastonite containing polyesters produced in accordance with the process of the present invention and articles derived from such films. The wollastonite reinforcing filler contained in such films provides the film with enhanced strength, abrasion resistance, stiffness, and other benefits. Polymeric films have a variety of uses, such as, for example, packaging, especially of foodstuffs; adhesives; tapes; insulators; capacitors; photographic development; x-ray development; and laminates. In particular, films made from carbon black containing polyesters in accordance with the process of the present invention can be useful, for example, in EMI shielding; as a protective film for microwave antennas; as a radome; as a sunshield; and in packaging for electrically sensitive products, such as electronics, conductive films, and charge-transporting components for electrographic imaging equipment. Films fashioned from the polyesters containing low levels of carbon black in accordance with the process of the present invention can be useful in laser marking for identification purposes.

The heat resistance of the film is an important factor in many of the above mentioned uses, and therefore a film having a higher melting point, T_{g}, and crystallinity level is desired in order to provide better heat resistance and more stable electrical characteristics to such films and the articles made thereform. Further, such films preferably have good barrier properties, such as, for example, to moisture, oxygen and carbon dioxide; good grease resistance; good tensile strength; and a high elongation at break.

Polyesters of the present invention can be formed into a film for use in any one of many different applications, such as, for example, packaging; labels; and EMI shielding. While not intended to be limiting, the monomer composition of the polyester being fashioned into a film is preferably chosen so as to result in a partially crystalline polyester, wherein crystallinity provides strength and elasticity. As first produced, a polyester is generally semi-crystalline in structure, but crystallinity increases as the polyester is reheated and/or stretched to form the desired film.

A film can be made from the polyester produced in accordance with the process of the present invention by any process known in the art. For example, thin films can be formed through dipcoating as taught in U.S. Pat. No. 4,372,311; through compression molding as taught in U.S. Pat. No. 4,427,614; through melt extrusion as taught in U.S. Pat. No. 4,880,592; and through melt blowing as taught in U.S. Pat. No. 5,525,281. A person of ordinary skill in the art will be familiar with other acceptable film forming processes.

The difference between a film and a sheet is the thickness, but there is no set industry standard as to when a film becomes a sheet. For purposes of this invention, a film is about 0.25 mm (10 mils) or less thick, and preferably between about 0.025 (1 mil) and 0.15 mm (6 mils). However, thicker films can be formed up to a thickness of about 0.50 mm (20 mils).

The film of the present invention is preferably formed by either solution casting, or extrusion. Extrusion is particularly preferred for formation of “endless” products, such as films and sheets, which emerge as a continuous length.

In extrusion, the polymeric material, whether provided as a molten polymer or as plastic pellets or granules, is fluidized and homogenized. If desired, additives, as described above, such as, for example, thermal or UV stabilizers; plasticizers; fillers; and/or blendable polymeric materials, can be added thereto. The polymeric mixture is then forced through a suitably shaped die to produce the desired cross-sectional film shape. The extruding force can be exerted by either a piston or ram (ram extrusion), or by a rotating screw (screw extrusion), wherein such extruding force is exerted in the cylinder in which the polymeric mixture is heated and plasticized. The mixture is extruded from the cylinder and through the die in a continuous flow. Single screw, twin screw, and multi-screw extruders can be used as known in the art. Different kinds of die can be used to produce different products, such as, for example, blown films, which are formed by a blow head for blown extrusions; sheets and strips, which are formed by slot dies; and hollow and solid sections, which are formed by circular dies. In this manner, films of differing widths and thickness can be produced. After extrusion, the polymeric film is taken up on rollers, cooled and taken off by devices designed to prevent any subsequent deformation of the film.

A film having the desired thickness can be produced by using extruders known in the art to extrude a thin layer of polymeric mixture onto chill rollers, and then using tension rolls to draw the film down to the desired size. In the extrusion casting process, the polymer melt is extruded through a slot die, such as, for example, a T-shaped or “coat hanger” die. The die may be as wide as 10 feet and typically has thick wall sections on the final lands to minimize deflection of the lips from the internal pressure. A wide range of die openings can be used, but typically the die opening ranges from about 0.015 to about 0.030 inches. The nascent cast film can be drawn down, and thinned significantly, depending on the speed of the rolls taking up the film. The film is subsequently solidified by being cooled below either the crystalline melting point, or T_{g}. The cooling can be accomplished by passing the film either through a water bath, or over two or more chrome-plated chill rolls that have been cored for cold water to pass through. The cast film is conveyed through nip rolls and a slitter to trim the edges, and is then wound up. In cast films, conditions can be tailored to allow a relatively high degree of orientation in the machine direction, especially at high draw down conditions and wind up speeds, and a much lower degree of orientation in the transverse direction. Alternatively, the conditions can be tailored to minimize the degree of orientation, thereby providing films with essentially equivalent physical properties in both the machine direction and the transverse direction. Preferably, the finished film is about 0.25 mm or less thick.

Blown films are made by extruding a tube, and are generally stronger, tougher, and made more rapidly than cast films. In producing a blown film, the melt flow of molten polymer is typically turned upward from the extruder and fed through an annular die. In so doing, the melt flows around a mandrel and emerges through a ring-shaped opening in the form of a tube. As the tube leaves the die, air is used to introduce internal pressure into the die mandrel. The internal pressure expands the tube from about 1.5 to about 2.5 times the die diameter and simultaneously draws the film causing a reduction in thickness. As one end of the expanded tube is sealed by the die and the other end by nip (or pinch) rolls, air is trapped therein forming a bubble. Preferably, an even air pressure is maintained to ensure uniform thickness of the blown film. The blown film can be cooled internally and/or externally by directing air into the film. Faster quenching can be accomplished by passing the expanded film about a cooled mandrel situated inside the bubble. For example, a method using a cooled mandrel is disclosed by Bunga et al. in Canadian Patent No. 893,216. If the polymer being used to prepare the blown film is semicrystalline, the bubble can become cloudy as it cools below the softening point of the polymer. The quenched bubble can then be moved upward through guiding devices and into a set of pinch rolls that flatten the bubble, thereby forming a sleeve that can then be slit along one side so as to produce a larger film width than could conveniently be made via the cast film method. The slit film can be further gusseted and surface-treated in-line. Drawing down of the extrudate is not essential, but preferably the draw down ratio is between about 2 and about 40. The draw down ratio is defined as the ratio of the die gap to the product of the thickness of the cooled film and the blow-up ratio. Draw down can be induced by tension from pinch rolls. Blow-up ratio is the ratio of the diameter of the cooled film bubble to the diameter of the circular die. The blow up ratio can be as great as 4 to 5, but is typically 2.5. Drawing down a film induces molecular orientation of the film in the machine direction, i.e. direction of the extrudate flow, and the blow-up ratio induces molecular orientation of the film in the transverse or hoop direction.

The blown film can also be produced through more elaborate techniques, such as, for example, the double bubble process; tape bubble process; and trapped bubble process. In the double-bubble process, the polymeric tube is first quenched and then reheated and oriented by inflating the polymeric tube above the T_{g}, but below the crystalline melting temperature (Tₘ) of the polyester (if the polyester is crystalline). The double bubble process is familiar to a person of ordinary skill in the art and has been described, for example, by Pahkle in U.S. Pat. No. 3,456,044.

The exact conditions needed to produce a blown film will be determined by a complex combination of many factors, such as, for example, chemical composition of the polymer; amount and type of additives being added; and the thermal properties of the polymeric composition. The blown film process offers many advantages, such as the relative ease with which the film width and caliber can be changed by a simple change in the volume of air in the bubble and the speed of the screw; the elimination of end effects; and the ability to provide a biaxially oriented film. A blown film is typically from about 0.004 to about 0.008 inches thick, and, after being slit, can be up to 24 feet or wider.

A sheeting calender can be used to manufacture large quantities of film. A sheeting calender is a machine comprising a gap and a number of heatable parallel cylindrical rollers rotating in opposite directions. A rough film is fed into the gap, wherein the rollers spread out and stretch the rough film to the required thickness. The final roller of the calender is either smooth to provide a film having a smooth surface, or is embossed with a pattern to provide a film having a textured surface. In the alternative, an embossed film can be produced by subsequently reheating a film having a smooth surface, and then passing such film through an embossing calender. The calender is followed by at least one cooling drum, and the finished film is then reeled up.

An extruded film can also be used to make other products. For example, the film can be cut into small segments and used as the feed material in a process for making molded articles, such as, for example, an injection molding process. In another example, an extruded film can be laminated onto a substrate as is further described below. In a further example, an extruded film can be metallized, as taught in the art. As yet a further example, film tubes produced in blown film process can be converted to bags through, for example, heat sealing processes.

Extrusion processes can be further combined with a variety of post-extrusion processes including, for example, changing round shapes to oval shapes; blowing the film to different dimensions; machining and punching; and biaxially stretching the film. A person of ordinary skill in the art is familiar with the variety of available post-extrusion processes.

Solution casting can also be used to make films, wherein solution casting consistently produces a more uniformly gauged film than melt extrusion. Solution casting comprises forming a polymeric solution by dissolving polymeric granules or powders in a suitable solvent with any desired formulant, such as a plasticizer or colorant. The solution is filtered to remove dirt and/or large particles, and is cast from a slot die onto a moving belt that is preferably comprised of stainless steel, dried, whereon the film cools. The extrudate thickness is five to ten times that of the finished film. The film can then be finished in a manner that is similar to the manner in which the extruded film described above is finished. One of ordinary skill in the art can identify the process parameters that are needed based on the polymeric composition and process used to form the film. The solution cast film can be subjected to the same post-extrusion processes described above for extrusion cast films.

Films having, for example, bilayer, trilayer, and multilayer film structures can also be produced. The specific properties of a multilayer film can advantageously be tailored to solve critical use needs by allowing more costly ingredients to be relegated to the outer layers where they provide the greatest benefit. Multilayer film structures can be formed through processes, such as, for example, coextrusion; blow film; dipcoating; solution coating; blade; puddle; air-knife; printing; Dahlgren; gravure; powder coating; and spraying.

Generally, multilayer films are produced through extrusion casting processes. For example, the polymer resin materials are uniformly heated until obtaining a mass of a molten material that is then conveyed to a coextrusion adapter that combines the layers of molten material into a multilayer structure. The multilayered structure is forced through an extrusion die opened to a predetermined gap, which is commonly in the range of between about 0.05 inch (0.13 cm) and about 0.012 inch (0.03 cm), and is then drawn down to the desired thickness by means of a primary chill or casting roll that is typically maintained at a temperature ranging from about 15-55° C. (60-130° F.). Typically, draw down ratios range from about 5:1 to about 40:1. The additional layers can serve, for example, as barrier layers; adhesive layers; or antiblocking layers. In addition, the inner layers can be filled and the outer layers can be unfilled as, for example, is disclosed in U.S. Pat. Nos. 4,842,741 and 6,309,736. Processes for producing multilayer films are well known in the art. See, for example, U.S. Pat. Nos. 4,522,203; 4,734,324; 5,261,899 and 6,309,736.

The additional layers can comprise either the polyesters of the present invention, or the blendable polymeric materials already set forth hereinabove in a non-limiting list.

Regardless of how a film is made, the film can be biaxially oriented by being stretched in both the machine and transverse directions. As a film is being formed, it can be stretched in the machine direction by simply being rolled out and taken up. Although stretching the film in the direction of takeup will orient some of the fibers and strengthen the film in the machine direction, the film can still be easily torn in the direction at right angles because all of the fibers are oriented in the same direction. A biaxially oriented film can further be subjected to additional drawing in the machine direction in a process known as tensilizing.

Biaxially oriented films have superior tensile strength, flexibility, toughness and shrinkability, for example, in comparison to non-oriented films because biaxially stretching a film orients the fibers parallel to the plane of the film, but leaves the fibers in the plane of the film randomly oriented. Preferably, the film is stretched along two axes at right angles to each other to increases tensile strength and elastic modulus in the directions of stretch. Preferably, the amount of stretch in each direction is roughly equivalent so that the film will have similar properties or behaviors when tested from any direction. Certain applications, however, such as, for example, those that need a certain amount of shrinkage or more strength in one direction than another, e.g. labels, adhesives and magnetic tapes, require the fibers of the film to be unevenly, or uniaxially oriented.

A film can be biaxially oriented via any process known in the art. Preferably, however, tentering is used to biaxially orient the film. In tentering, the film is stretched (while being heated) in the transverse direction, either simultaneously with, or subsequent to, being stretched in the machine direction. Films can be biaxially orientated with available commercial equipment, such as, for example, is available from Bruckner Maschenenbau of West Germany. One such piece of equipment clamps the edges of the sheet to be drawn and, at the appropriate temperature, brings the edges together and apart at a controlled rate. For example, a film can be fed into a temperature-controlled box, heated above the T_{g}, and grasped on either side by tenterhooks that simultaneously exert a drawing tension (longitudinal stretching) and a widening tension (lateral stretching). Typically, stretch ratios of 3:1 to 4:1 can be employed. Alternatively, and preferably for commercial purposes, the biaxial drawing process is conducted continuously at high production rates in multistage roll drawing equipment, as is available from Bruckner, wherein the extruded film is drawn in a series of steps that takes place between heated rolls rotating at different and increasing rates. When draw temperatures and rates are appropriately combined, monoaxial stretching will preferably be from about 4 to about 20, and more preferably from about 4 to about 10. Draw ratio is defined as the ratio of a dimension of a stretched film to a non-stretched film.

A film can be uniaxially oriented by either being stretched in only one direction in accordance with the above described biaxial process, or directing the film through a machine direction orienter (MDO) such as is commercially available from vendors such as the Marshall and Williams Company of Providence, R.I. The MDO apparatus has a plurality of stretching rollers that progressively stretch and thin the film in the machine direction, which is the direction of travel of the film through the apparatus.

Preferably, the stretching process takes place at a temperature of at least about 10° C. above the T_{g} of the film material, and preferably below the Vicat softening temperature of the film material, especially at least about 10° C. below the Vicat softening point, depending to some degree on the rate of stretching.

Orientation can be enhanced in blown film operations by adjusting the blow-up ratio (BUR), which is defined as the ratio of the diameter of the film bubble to the die diameter. For example, when producing bags or wraps, a BUR of 1 to 5 is generally preferred, but may be modified depending on the balance of properties desired in the machine direction and the transverse direction. For a balanced film, a BUR of about 3:1 is generally appropriate. If it is desired to have a “splitty” film that easily tears in one direction, then a BUR of about 1:1 to about 1.5:1 is generally preferred.

Shrinkage can be controlled by holding the film in a stretched position and heating for a few seconds before quenching. The heat stabilizes the oriented film, which in turn can result in a film that only shrinks at temperatures above the heat stabilization temperature. Further, the film can also be subjected to rolling, calendering, coating, embossing, printing, or any other typical finishing operations known in the art.

The above process conditions and parameters for making a film in accordance with any known process are easily determined by a skilled artisan for any given polymeric composition and desired application.

The properties exhibited by a film can depend on several of the factors already indicated above, including, for example, the polymeric composition; the method of forming the polymer; the method of forming the film; whether the film was treated for stretch; and whether the film was biaxially oriented. Such factors affect many properties of the film, such as, for example, shrinkage; tensile strength; elongation at break; impact strength; electrical properties; tensile modulus; chemical resistance; melting point; heat deflection temperature; and deadfold performance.

The film properties can be further adjusted by adding certain additives and fillers to the polymeric composition wherein a non-limiting list of at least some examples of additives and fillers is already set forth hereinabove. Alternatively, the polyester compositions of the present invention can be blended with one or more other polymeric materials, wherein a non-limiting list of at least some examples of blendable polymeric materials is already set forth hereinabove.

As disclosed by Moss in U.S. Pat. No. 4,698,372; Haffner et al. in U.S. Pat. No. 6,045,900; and McCormack in WO 95/16562, films, especially filled films, can, if desired, be microporous, that is formed so as to contain micropores. Additional disclosures related to microporous films can be found in U.S. Pat. No. 4,626,252; U.S. Pat. No. 5,073,316; and U.S. Pat. No. 6,359,050. As is known, the stretching of a filled film can create fine pores that prevent liquid and particulate matter from passing through, but allow air and water vapor to pass through.

The films of the present invention can also be treated by known conventional post forming operations, such as, for example, corona discharge; chemical treatments; and flame treatments so as to enhance, for example, the film's printability; receptivity of the surface of the film to ink; and the film's adhesion, as well as, other desirable characteristics.

The films can also be further processed to produce articles, such as, for example, containers. For example, the films can be thermoformed as disclosed, for example, in U.S. Pat. No. 3,303,628, U.S. Pat. No. 3,674,626, and U.S. Pat. No. 5,011,735. The films can also be laminated onto substrates as is further described below.

A further preferred aspect of the present invention relates to applying a coating comprising the polyesters of the present invention to a substrate, the process for producing such a coating, and articles derived therefrom. The wollastonite reinforcing filler contained in the polyesters produced in accordance with the process of the present invention provides enhanced strength, abrasion resistance, stiffness, and other benefits to the coatings produced therefrom. The substrate can be coated, for example, with a solution, dispersion, latex, or emulsion of the polyesters of the present invention via, for example, a rolling, spreading, spraying, brushing, or pouring coating process that is followed by drying; by coextruding the polyesters of the present invention with other materials; by powder coating the polyesters of the present invention onto the preformed substrate; or by melt/extrusion coating a preformed substrate with the polyesters of the present invention. The substrate can be coated either on one side, or on both sides. The polymeric coated substrates have a variety of uses, such as in packaging, especially static charge dissipative packaging used to package, for example, sensitive electronic parts, semiconductive cable jackets, and EMI shielding, and in disposable products. For many of these uses, the heat resistance of the coating is an important factor, and better heat resistance can be provided by a higher melting point, T_{g}, and crystallinity level. Further, such coatings are preferably good barriers against, for example, moisture, grease, oxygen, and carbon dioxide, and also preferably have good tensile strength and high elongation at break.

The polyester coating of the present invention can be made in accordance with any process known in the art. For example, thin coatings can be formed through dipcoating, as disclosed, for example, in U.S. Pat. No. 4,372,311 and U.S. Pat. No. 4,503,098; extrusion onto substrates, as disclosed, for example, in U.S. Pat. No. 5,294,483, U.S. Pat. No. 5,475,080, U.S. Pat. No. 5,611,859, U.S. Pat. No. 5,795,320, U.S. Pat. No. 6,183,814, and U.S. Pat. No. 6,197,380; blade; puddle; air-knife; printing; Dahlgren; gravure; powder coating; and spraying. The coatings of the present invention can have any thickness, but preferably the coating thickness is less than or equal to 0.25 mm (10 mils), and more preferably is between about 0.025 mm (1 mil) and about 0.15 mm (6 mils). The coatings, however, can be as thick as up to about 0.50 mm (20 mils) or more.

Various substrates can be directly coated with a film. The coating of the present invention is preferably applied via solution, dispersion, latex, and emulsion casting; powder coating; or extrusion onto a preformed substrate.

Solution casting can also be used to make coatings, wherein solution casting consistently produces a more uniformly gauged coating than melt extrusion. Solution casting involves dissolving polymeric granules, powders or the like in a suitable solvent with any desired formulant, such as a plasticizer, filler, blendable polymeric material, or colorant. The solution is filtered to remove dirt and/or large particles, and is cast from a slot die onto a moving preformed substrate, dried, whereon the coating cools. The extrudate thickness is five to ten times that of the finished coating. The solution cast coating can then be finished in a manner similar to the manner in which an extruded coating is finished. Similarly, polymeric dispersions and emulsions can be coated onto substrates through equivalent processes. The coatings can be applied to, for example, textiles; nonwovens; foil; paper; paperboard; and other sheet materials via a continuously operating spread-coating machine. A coating knife, such as a “doctor knife”, ensures uniform spreading of the coating materials (in the form of solution, emulsions, or dispersions in water or an organic medium) on the supporting material, which is moved along by rollers. The coating is then dried. Alternatively, the polymeric solution, emulsion, or dispersion can be sprayed, brushed, rolled or poured onto the substrate.

Potts, for example, discloses in U.S. Pat. No. 4,372,311 and U.S. Pat. No. 4,503,098 that water-soluble substrates can be coated with solutions of water-insoluble materials. U.S. Pat. No. 3,378,424, for example, discloses processes for coating a fibrous substrate with an aqueous polymeric emulsion.

The polymers of the present invention can also be applied to a substrate through a powder coating process. In a powder coating process, the polymers are applied to the substrate in the form of a powder having fine particle sizes. The substrate being coated, however, is first heated to a temperature above the fusion temperature of the polymer, wherein the heated substrate is subsequently dipped into a bed of polymer powder fluidized by the passage of air through a porous plate. The fluidized bed is typically not heated. A layer of the polymer adheres to the hot substrate surface and melts to provide the coating. Coating thicknesses can range from about 0.005 inch (0.13 mm) to about 0.080 inch (2.00 mm). Other powder coating processes include spray coating, wherein the substrate is not heated until after it is coated, and electrostatic coating. For example, U.S. Pat. No. 4,117,971; U.S. Pat. No. 4,168,676; U.S. Pat. No. 4,180,844; U.S. Pat. No. 4,211,339; and U.S. Pat. No. 4,283,189 disclose that paperboard containers can be electrostatically spray-coated with a thermoplastic polymer powder, wherein the containers are heated to melt the powder and form a laminated coating.

A whirl sintering process can also be used to coat metal articles of complex shapes with the polymeric films of the present invention. The articles are heated to a temperature above the melting point of the polymer, and are then introduced into a fluidized bed of polymer powder, wherein polymer particles that are suspended by a rising stream of air are deposited as a coating onto the article by sintering.

Coatings of the present invention can also be applied by spraying molten atomized polymeric compositions onto the surface of a substrate, such as paperboard. U.S. Pat. No. 5,078,313; U.S. Pat. No. 5,281,446; and U.S. Pat. No. 5,456,754, for example, disclose such a process for wax coatings.

The coatings of the present invention are preferably formed via melt or extrusion coating processes. Extrusion coating is particularly preferred for forming “endless” products, such as coated paper and paperboard that emerge as a continuous length. In extrusion coating, the polymeric material, whether provided as a molten polymer or as plastic pellets or granules, is fluidized and homogenized. Additives, as already described above, such as, for example, thermal or UV stabilizers, plasticizers, fillers and/or blendable polymeric materials, can be added to the polymeric material during the extrusion coating process. The mixture is then forced through a suitably shaped die to produce the desired cross-sectional film shape. The extruding force can be exerted by either a piston or ram (ram extrusion), or by a rotating screw (screw extrusion), wherein the extruding force is exerted in the cylinder in which the polymeric mixture is heated and plasticized. The mixture is extruded from the cylinder and through the die in a continuous flow. Single screw, twin screw, and multi-screw extruders can be used as known in the art. Typically, slot dies, such as T-shaped or “coat hanger” dies, are used in extrusion coating processes. In this manner, films of differing widths and thickness can be produced, and then subsequently extruded directly onto the object being coated. A thin molten nascent film exits the die and is pulled down onto the substrate and into a nip between a chill roll and a pressure roll situated directly below the die. The nip rolls are generally a pair of cooperating axially parallel rolls, wherein one is a pressure roll having a rubber surface and the other is a chill roll. Typically, the uncoated side of the substrate contacts the pressure roll while the polymer-coated side of the substrate contacts the chill roll. The pressure between the chill roll and pressure roll forces the film onto the substrate. The substrate moves at a faster speed than the extruded film, thereby drawing the film down to the required thickness. In extrusion coating, the substrate, e.g. paper, foil, fabric, and polymeric film, and extruded polymeric film melt are compressed together by the pressure rolls so that the polymer impregnates the substrate for maximum adhesion. The molten film is then cooled by water-cooled chromium-plated chill rolls. The coated substrate passes through a slitter to trim the edges, and is then removed by a device designed to prevent the coated substrate from being deformed.

Extrusion coating polyesters onto paperboard is known in the art as, for example, is disclosed in U.S. Pat. Nos. 3,924,013; 4,147,836; 4,391,833; 4,595,611; 4,957,578; and 5,942,295. For example, Kane disclose in U.S. Pat. No. 3,924,013 that ovenable trays can be mechanically formed from paperboard previously laminated with polyester. Chaffey et al., for example, discloses in U.S. Pat. No. 4,836,400 that cups can be formed from paper stock that has a polymer coating on both sides. Beavers et al., for example, discloses in U.S. Pat. No. 5,294,483 that certain polyesters can be extrusion coated onto paper substrates.

An extrusion coating process can also be used to directly sheath wires and cables with polymeric films extruded from oblique heads.

Calendering processes can also be used to apply a polymeric laminate to a substrate. Calenders can consist of two, three, four, or five hollow rolls arranged for steam heating or water cooling. Typically, the polymer to be calendered is softened, for example in a ribbon blender, such as a Banbury mixer. Other components, such as plasticizers, can be added to the softened polymer. The softened polymeric composition can then be fed to the roller arrangement and squeezed into the form of a film. If desired, thick sections can be formed by applying one layer of polymer onto a previous layer (double plying). A substrate, such as a textile, nonwoven fabric or paper, is fed through the last two rolls of the calender where the resin film is pressed onto the substrate, and then allowed to cool. The thickness of the laminate is determined by the gap between the last two rolls of the calender. The surface can be made glossy, matte, or embossed. The laminated substrate is wound up on rolls.

Multiple polymer layer films can also be coated on a substrate, wherein such films have bilayer, trilayer, and multilayer film structures. The specific properties of a multilayer film can be advantageously tailored to solve critical use needs while allowing the more costly ingredients to be relegated to the outer layers where they provide the most benefit. Multilayer films can be formed, for example, through coextrusion; dipcoating; solution coating; blade; puddle; air-knife; printing; Dahlgren; gravure; powder coating; and spraying. Generally, multilayer films are produced through extrusion casting processes. For example, resin materials are uniformly heated to form a mass of a molten material that is then conveyed to a coextrusion adapter that combines the layers of molten material into a multilayer structure. The layered polymeric material is transferred through an extrusion die opened to a predetermined gap, commonly in the range of between about 0.05 inch (0.13 cm) and 0.012 inch (0.03 cm). The material is pulled down onto a substrate and into a nip between a chill roll and a pressure roll situated directly below the die. The material is drawn down to the intended gauge thickness based on the speed of the substrate. Typical draw down ratios range from about 5:1 to about 40:1. The primary chill or casting roll is typically maintained at a temperature in the range of from about 15-55° C. (60-130° F.). The additional layers can serve as, for example, barrier layers; adhesive layers; and/or antiblocking layers. Furthermore, for example, the inner layers can be filled and the outer layers can be unfilled, as is disclosed in U.S. Pat. No. 4,842,741 and U.S. Pat. No. 6,309,736. Processes for producing multilayer films are well known in the art. See, for example, U.S. Pat. Nos. 4,522,203; 4,734,324; 5,261,899 and 6,309,736

The additional layers can be comprised of either the polyesters of the present invention, or of the polymeric blend materials already set forth hereinabove in a non-limiting list.

Preferably, the coating is applied in a thickness of about 0.2 to 15 mils, and more preferably of about 0.5 to 2 mils. The thickness of the substrate can vary widely, but commonly ranges from about 0.5 to more than about 24 mils. Suitable substrates for the present invention include, but are not limited to, articles composed of paper; paperboard; cardboard; fiberboard; cellulose, such as Cellophane®; starch; plastic; polystyrene foam; glass; metal, for example, aluminum or tin cans; metal foils; polymeric foams; organic foams; inorganic foams; organic-inorganic foams; and polymeric films. This should not be considered limiting as essentially any substrate known can find utility in the present invention.

To enhance the coating process, the substrate can be treated by known conventional post forming operations, such as, for example, corona discharge; chemical treatments; and flame treatments. The substrate can be primed with, for example, an aqueous solution of polyethyleneimine (Adcote® 313) or a styrene-acrylic latex; or may be flame treated as disclosed, for example, in U.S. Pat. No. 4,957,578 and U.S. Pat. No. 5,868,309.

The substrate can also be coated with an adhesive, either through conventional coating technologies or through extrusion. Specific examples of adhesives that may be useful in the present invention include, but are not limited to, glue; gelatine; casein; starch; cellulose esters; aliphatic polyesters; poly(alkanoates); aliphatic-aromatic polyesters; sulfonated aliphatic-aromatic polyesters; polyamide esters; rosin/polycaprolactone triblock copolymers; rosin/poly(ethylene adipate) triblock copolymers; rosin/poly(ethylene succinate) triblock copolymers; poly(vinyl acetates); poly(ethylene-co-vinyl acetate); poly(ethylene-co-ethyl acrylate); poly(ethylene-co-methyl acrylate); poly(ethylene-co-propylene); poly(ethylene-co-1-butene); poly(ethylene-co-1-pentene); poly(styrene); acrylics; Rhoplex® N-1031 (an acrylic latex from the Rohm & Haas Company); polyurethanes; AS 390 (an aqueous polyurethane adhesive base for Adhesion Systems, Inc.) with AS 316 (an adhesion catalyst from Adhesion Systems, Inc.); Airflex® 421 (a water-based vinyl acetate adhesive formulated with a crosslinking agent); sulfonated polyester urethane dispersions, such as, for example, are sold by the Bayer Corporation as Dispercoll® U-54, Dispercoll® U-53, and Dispercoll® KA-8756; nonsulfonated urethane dispersions, such as, for example, are sold by the Reichold Company as Aquathane® 97949 and Aquathane® 97959, the Air Products Company as Flexthane® 620 and Flexthane® 630, the BASF Corporation as Luphen® D DS 3418 and Luphen® D 200A, the Zeneca Resins Company as Neorez® 9617 and Neorez® 9437, the Merquinsa Company as Quilastic® DEP 170 and Quilastic® 172, and the B. F. Goodrich Company as Sancure® 1601 and Sancure® 815; urethane-styrene polymer dispersions, such as, for example, are sold by the Air Products & Chemicals Company as Flexthane® 790 and Flexthane® 791; non-ionic polyester urethane dispersions, such as, for example, are sold by Zeneca Resins as Neorez® 9249; acrylic dispersions, such as, for example, are sold by the Jager Company as Jagotex® KEA-5050 and Jagotex® KEA 5040, B. F. Goodrich as Hycar® 26084, Hycar® 26091, Hycar® 26315, Hycar® 26447, Hycar® 26450, and Hycar® 26373, and the Rohm & Haas Company as Rhoplex® AC-264, Rhoplex® HA-16, Rhoplex® B-60A, Rhoplex® AC-234, Rhoplex® E-358, and Rhoplexe N-619; silanated anionic acrylate-styrene polymer dispersions, such as, for example, are sold by the BASF Corporation as Acronal® S-710 and Scott Bader, Inc. as Texigel® 13-057; anionic acrylate-styrene dispersions, such as, for example, are sold by the BASF Corporation as Acronal® 296D, Acronal® NX 4786, Acronal® S-305D, Acronal® S400, Acronal® S-610, Acronal® S-702, Acronal® S-714, Acronal® S-728, and Acronale S-760, B. F. Goodrich as Carboset® CR-760, Rohm & Haas as Rhoplex® P-376, Rhoplex® P-308, and Rhoplex® NW-1715K, Reichold Chemicals as Synthemul® 40402 and Synthemul® 40403, Scott Bader, Inc. as Texigel® 13-57, Texigel® 13-034, and Texigel® 13-031, and the Air Products & Chemicals Company as Vancryl® 954, Vancryl® 937 and Vancryl® 989; anionic acrylate-styrene-acrylonitrile dispersions, such as, for example, are sold by BASF Corporation as Acronal® S 886S, Acronal® S 504, and Acronal® DS 2285 X; acrylate-acrylonitrile dispersions, such as, for example, are sold by BASF Corporation as Acronal® 35D, Acronal® 81 D, Acronal® B 37D, Acronal® DS 3390, and Acronal® V275; vinyl chloride-ethylene emulsions, such as, for example, are sold by Air Products and Chemicals as Vancryl® 600, Vancryl® 605, Vancryl® 610, and Vancryl® 635; vinylpyrrolidone/styrene copolymer emulsions, such as, for example, are sold by ISP Chemicals as Polectron® 430; carboxylated and noncarboxylated vinyl acetate ethylene dispersions, such as, for example, are sold by Air Products and Chemicals as Airflex® 420, Airflex® 421, Airflex® 426, Airflex® 7200, and Airflex® A-7216, and ICI as Dur-o-set® E150 and Dur-o-set® E-230; vinyl acetate homopolymer dispersions, such as, for example, are sold by ICI as Resyn® 68-5799 and Resyn® 25-2828; polyvinyl chloride emulsions, such as, for example, are sold by B. F. Goodrich as Vycar® 460×24, Vycar® 460×6 and Vycar® 460×58; polyvinylidene fluoride dispersions, such as, for example, are sold by Elf Atochem as Kynar® 32; ethylene acrylic acid dispersions, such as, for example, are sold by Morton International as Adcote® 50T4990 and Adcote® 50T4983; polyamide dispersions, such as, for example, are sold by the Union Camp Corporation as Micromid® 121RC, Micromid® 141L, Micromid® 142LTL, Micromid® 143LTL, Micromid® 144LTL, Micromid® 321RC, and Micromid® 632HPL; anionic carboxylated or noncarboxylated acrylonitrile-butadiene-styrene emulsions and acrylonitrile emulsions, such as, for example, are sold by B. F. Goodrich as Hycar® 1552, Hycar® 1562×107, Hycar® 1562×117 and Hycar® 1572×64; resin dispersions derived from styrene, such as, for example are sold by Hercules as Tacolyn® 5001 and Piccotex® LC-55WK; resin dispersions derived from aliphatic and/or aromatic hydrocarbons, such as, for example are sold by Exxon as Escorez® 9191, Escorez® 9241, and Escorez® 9271; styrene-maleic anhydrides, such as, for example, are sold by AtoChem as SMA® 1440 H and SMA® 1000; and mixtures thereof. This should not be taken as limiting as essentially any known adhesive can be used in the present invention.

The adhesives can be applied through either a melt process, or a solution, emulsion, dispersion, or coating process.

U.S. Pat. No. 4,343,858, for example, discloses a coating process wherein a paperboard is coated with a polyester top film that is coextruded with an intermediate layer of an ester of acrylic acid, methacrylic acid, or ethacrylic acid. U.S. Pat. No. 4,455,184, for example, further discloses a process wherein a polyester layer is coextruded with a polymeric adhesive layer onto a paperboard substrate. Fujita et al., for example, disclose in U.S. Pat. No. 4,543,280 that an adhesive can be used in the extrusion coating of a polyester onto ovenable paperboard. Huffman et al., for example, disclose in U.S. Pat. No. 4,957,578 that a polyester layer can be extruded onto a polyethylene coated paperboard, wherein the polyethylene layer can be corona discharge or flame treated to promote adhesion. Huffman et al. further disclose that the polyester-polyethylene-paperboard structure can be directly formed by coextruding the polyester and polyethylene, wherein a coextruded adhesive tie layer of Bynel® is contained between the polyethylene layer and the polyester layer.

A person of ordinary skill in the art can readily determine the process conditions and parameters needed to coat a substrate with any given polymeric composition, including the polyester compositions of the present invention, by using any method known in the art. A person of ordinary skill in the art can also readily determine how to choose an appropriate coating for a desired application.

The coating properties will depend on the combination of factors already set forth hereinabove, including, for example, the polymeric composition; the method of forming the polymer; the method of forming the coating; and whether the coating is oriented during manufacture. Such factors affect many properties of the coating, such as, for example, shrinkage; tensile strength; elongation at break; impact strength; electrical properties; tensile modulus; chemical resistance; melting point; and heat deflection temperature.

Coating properties can be further adjusted by adding additives and fillers to the polymeric coating composition, wherein a non-limiting list of at least some examples of additives and fillers is already set forth hereinabove. Alternatively, the polyesters of the present invention can be blended with at least one other polymeric material to improve certain characteristics already described above, wherein a non-limiting list of at least some examples of such polymeric materials is already set forth hereinabove.

The substrate can be formed into an article either prior to, or after, being coated. For example, containers can be produced from flat coated paperboard by being press formed; vacuum formed; or folded and adhered to form the desired shape. Flat coated paperboard can either be formed into trays through the application of heat and pressure, as disclosed in, for example, U.S. Pat. No. 4,900,594, or be vacuum formed into containers as disclosed in U.S. Pat. No. 5,294,483. The formed articles can include, for example, mailing tubes; light fixtures; containers; cartons; boxes; cups; two-piece cups; one-piece pleated cups; cone cups; lidding; lids; cup tops; packaging; support boxes; plates; bowls; vending plates; trays; baking trays; microwavable dinner trays; disposable single use liners that can be utilized with containers such as cups or containers; substantially spherical objects; bottles; jars; crates; dishes; interior packaging, such as partitions, liners, anchor pads, corner braces, corner protectors, clearance pads, hinged sheets, trays, funnels, cushioning materials, and other objects used in packaging, storing, shipping, portioning, serving, or dispensing an object in a container.

A further preferred aspect of the present invention includes laminating the polyesters of the present invention onto a substrate, the process for producing the polyester laminate, and the articles derived therefrom. The wollastonite reinforcing filler contained in the polyesters produced in accordance with the process of the present invention provides enhanced strength, abrasion resistance, stiffness, and other benefits to the laminates of the present invention. A film comprising polyesters prepared in accordance with the present invention can be laminated on a wide variety of substrates through any known prior art process, including, for example, thermoforming; vacuum thermoforming; vacuum lamination; pressure lamination; mechanical lamination; skin packaging; and adhesion lamination. A laminate is differentiated from a coating in that a laminate involves attaching a preformed film to a substrate. The substrate can either be in the final use shape, such as in the form of a plate, cup, bowl, or tray, or be in an intermediate shape, such as a sheet or film. The film can be attached to the substrate via heat and/or pressure such as, for example, is available from heated bonding rolls. Generally speaking, the laminate bond strength or peel strength can be enhanced by using higher temperatures and/or pressures. When adhesives are used, the adhesives can be a hot melt or solvent based adhesive. To enhance the lamination process, the films and/or the substrates of the present invention can be treated by known conventional post forming operations, such as, for example, have already been described in a non-limiting set forth hereinabove. U.S. Pat. No. 4,147,836, for example, discloses that the lamination of a paperboard substrate with a poly(ethylene terephthalate) film can be enhanced by subjecting the paperboard to a corona discharge. Quick et al. further disclose, for example, in U.S. Pat. No. 4,900,594 that a polyester film can be corona treated to aide in laminating a paperstock with adhesives. Schirmer, for example, discloses in U.S. Pat. No. 5,011,735 that corona treatments can be used to aid in the adhesion between various blown films. U.S. Pat. No. 5,679,201 and U.S. Pat. No. 6,071,577, for example, disclose that flame treatments can be used as adhesion aids in polymeric lamination processes. Sandstrom et al., for example, disclose in U.S. Pat. No. 5,868,309 that a paperboard substrate primer consisting of certain styrene-acrylic materials can be used to improve the adhesion with polymeric laminates.

Processes for producing polymeric coated or laminated paper and paperboard substrates for use as containers and cartons are well known in the art. Examples of such processes are disclosed, for example, in U.S. Pat. Nos. 3,863,832; 3,866,816; 4,337,116; 4,456,164; 4,698,246; 4,701,360; 4,789,575; 4,806,399; 4,888,222; and 5,002,833. For example, Kane discloses in U.S. Pat. No. 3,924,013 that ovenable trays can be mechanically formed from paperboard previously laminated with polyester. Schmidt, for example, discloses a process for the polymeric film lamination of paper cups in U.S. Pat. No. 4,130,234. U.S. Pat. No. 6,045,900 and U.S. Pat. No. 6,309,736 disclose, for example, the lamination of films onto nonwoven fabrics. Depending on the intended use of the polyester laminated substrate, the substrate can be laminated on one or both sides.

In laminating the films of the present invention onto flat substrates, the films can be passed through heating and pressure/nip rolls. More commonly, the films of the present invention are laminated onto a substrate via a process derived from thermoforming. As such, the films may be laminated onto substrates through, for example, vacuum, pressure, blow, and/or mechanical lamination. When the films of the present invention are heated, they soften and may be stretched onto a substrate of any given shape. Processes for adhering a polymeric film to a preformed substrate are disclosed, for example, in U.S. Pat. No. 2,590,221.

In vacuum lamination, a substrate is laminated with the film of the present invention by clamping or simply holding the film against the substrate. The film is heated until becoming soft, and then a vacuum is applied, typically through the pores or designed-in holes of the substrate, that causes the softened film to mold into the contours of the substrate. The as formed laminate is then cooled. The vacuum can, but does not have to be, maintained during the cooling process.

For substrate shapes that require a deep draw, such as, for example, cups, deep bowls, boxes, and cartons, a plug assist may be utilized. In such substrate shapes, the softened film tends to thin out significantly before it reaches the base or bottom of the substrate shape, leaving only a thin and weak laminate on the bottom of the substrate shape. A plug assist is any type of mechanical helper that carries more film stock to an area of the substrate where the lamination would otherwise be too thin. Plug assist techniques can be adapted to vacuum and pressure lamination processes.

Vacuum laminating processes are known in the art as is disclosed, for example, in U.S. Pat. No. 4,611,456 and U.S. Pat. No. 4,862,671. Knoell, for example, discloses in U.S. Pat. No. 3,932,105 a process for vacuum laminating a film onto a folded paperboard carton. Lee et al., for example, discloses in U.S. Pat. No. 3,957,558 a process for vacuum laminating a thermoplastic film onto a molded pulp product, such as a plate. Foster et al., for example, discloses in U.S. Pat. No. 4,337,116 a process for laminating a poly(ethylene terephthalate) film onto a preformed molded pulp container by preheating the pulp container and the film, pressing the film into contact with the pulp container and applying vacuum through the pulp container.

Plug assisted vacuum lamination processes are also known in the art. Wommelsdorf et al., for example, disclose in U.S. Pat. No. 4,124,434 that plug assisted lamination processes can be used to laminate deep drawn laminates, such as coated cups. Faller, for example, discloses in U.S. Pat. No. 4,200,481 and U.S. Pat. No. 4,257,530 a plug assisted vacuum lamination process for producing lined trays.

Pressure lamination is the opposite of vacuum lamination. The film of the present invention can be clamped, heated until it softens, and then forced into the contours of the substrate to be laminated by applying air pressure to the side of the film that does not face the substrate. The substrate may contain exhaust holes to allow the trapped air to escape, or in the more common situation, the substrate may be porous to air so that the air is able to simply escape through the substrate. The air pressure can be released once the laminated substrate cools and the film solidifies. Pressure lamination tends to allow a faster production cycle, improved part definition, and greater dimensional control over vacuum lamination.

Pressure laminating films onto preformed substrates is known in the art as, for example, is disclosed in U.S. Pat. No. 3,657,044 and U.S. Pat. No. 4,862,671. For example, Wommelsdorf, in U.S. Pat. No. 4,092,201, discloses a process a process for lining an air-permeable container, such as a paper cup, with a thermoplastic foil by using a warm pressurized stream of gas.

Mechanical lamination includes any lamination method that does not use vacuum or air pressure. In this method, the film of the present invention is heated and then mechanically applied to the substrate. Examples of the mechanical application may include molds or pressure rolls.

Substrates suitable for lamination include, but are not limited to, articles composed of paper; paperboard; cardboard; fiberboard; cellulose, such as Cellophane®; starch; plastic; polystyrene foam; glass; metal, for example, aluminum or tin cans; metal foils; polymeric foams; organic foams; inorganic foams; organic-inorganic foams; and polymeric films.

The substrates can be formed into their final shape prior to lamination. Any conventional substrate forming process can be used. For example, a “precision molding”, “die-drying”, and/or “close-drying” process can be used to mold pulp substrates. The processes include molding fibrous pulp from an aqueous slurry against a screen-covered open-face suction mold to the substantially finished contoured shape, followed by drying the damp pre-form under a strong pressure applied by a mated pair of heated dies. Such processes are disclosed, for example, in U.S. Pat. No. 2,183,869, U.S. Pat. No. 4,337,116, and U.S. Pat. No. 4,456,164. Precision molded pulp articles tend to be dense, hard and boardy, with an extremely smooth, hot-ironed finish on the surface. Disposable paper plates produced by such processes have been sold by the Huhtamaki Company under the tradename “Chinet”.

Molded pulp substrates can also be produced through the commonly known “free-dried” or “open-dried” processes. In the free-dried process, an aqueous slurry of fibrous pulp is first molded via a screen-covered open-faced suction mold to essentially the final molded shape, and then dried in a free space by, for example, placing the pre-form on a conveyor and moving it slowly through a heated drying oven. Molded pulp substrates tend to be characterized by a non-compacted consistency, resilient softness, and irregular fibrous feel and appearance. Molded pulp substrates, after being formed via a free-dried process, can also be after pressed such as, for example, is disclosed in U.S. Pat. No. 2,704,493. Molded pulp substrates can also be produced through other conventional art process, such as is disclosed, for example, in U.S. Pat. No. 3,185,370.

Laminated substrates can be converted to the final shape through well known art processes, such as for, example, press forming or folding up. Such processes are disclosed, for example, in U.S. Pat. No. 3,924,013; U.S. Pat. No. 4,026,458; and U.S. Pat. No. 4,456,164. Quick et al., in U.S. Pat. No. 4,900,594, for example, disclose using pressure and heat to produce trays from flat polyester laminated paperstock.

As indicated above, adhesives can enhance the bond strength of the laminate by being applied to the film of the present invention, to the substrate, or to the film and the substrate. Adhesive lamination of films onto preformed substrates is known in the art as is disclosed, for example, in U.S. Pat. No. 2,434,106; U.S. Pat. No. 2,510,908; U.S. Pat. No. 2,628,180; U.S. Pat. No. 2,917,217; U.S. Pat. No. 2,975,093; U.S. Pat. No. 3,112,235; U.S. Pat. No. 3,135,648; U.S. Pat. No. 3,616,197; U.S. Pat. No. 3,697,369; U.S. Pat. No. 4,257,530; U.S. Pat. No. 4,016,327; U.S. Pat. No. 4,352,925; U.S. Pat. No. 5,037,700; U.S. Pat. No. 5,132,391; and U.S. Pat. No. 5,942,295. Schmidt, for example, discloses in U.S. Pat. No. 4,130,234 that hot melt adhesives can be used in laminating polymeric films to paper cups. Dropsy, for example, discloses in U.S. Pat. No. 4,722,474 that adhesives can be used for plastic laminated cardboard packaging articles. Quick et al., for example, discloses in U.S. Pat. No. 4,900,594 that pressure and heat can be used to form paperboard trays from a flat polyester laminated paperboard stock adhered with a crosslinkable adhesive system. Martini et al., for example, disclose in U.S. Pat. No. 5,110,390 that adhesives can be used to laminate coextruded bilayer films to water soluble substrates. Gardiner, for example, discloses in U.S. Pat. No. 5,679,201 and U.S. Pat. No. 6,071,577 that adhesives can be used to improve the bond strength between polyester and polyethylene coated paperboard layers of the paperboard used to produce, for example, juice containers.

The film can be coated either through conventional coating technologies or through coextrusion with an adhesive; the substrate can be coated with an adhesive; or both the film and the substrate can be coated with an adhesive. A non-limiting list of adhesives that may be useful in the present invention is already provided hereinabove.

The polyesters produced in accordance with the processes of the present invention can also be used to form sheets. The wollastonite reinforcing filler contained in such polyesters provides enhanced strength, abrasion resistance, stiffness, and other benefits to the sheets of the present invention. Polymeric sheets have a variety of uses, such as, for example, in signage, glazings, thermoforming articles, displays and display substrate. For many of these uses, the heat resistance of the sheet is an important factor. As a result, a higher melting point, T_{g}, and crystallinity level are desirable to provide better heat resistance and greater stability. Further, it is desired that the sheets have ultraviolet (UV) and scratch resistance; good tensile strength; high optical clarity; and a good impact strength, particularly at low temperatures.

The carbon black contained in the polyesters produced in accordance with the process of the present invention enables the sheet to dissipate electrical charges that form on the sheet as it is being electrostatically painted so that an even coating of paint can be applied over the entire sheet. As a result, relatively large sheets can be consistently painted so as to have no color differences over the surface of the sheet. A significant advantage of the carbon black containing polyester sheets of the present invention is the ability to electrostatically paint such sheets, wherein due to the low carbon loadings such sheets are able to maintain a majority of the physical properties desired. Carbon black containing polyester sheets produced in accordance with the process of the present invention can be used in laser marking for identification purposes.

Various polymeric compositions have been used in an attempt to meet all of the above criteria. In particular, poly(ethylene terephthalate) (PET) has been used to form low-cost sheets for many years. However, PET sheets have poor low temperature impact strength; low T_{g}; and high rate of crystallization. As a result, PET sheets cannot be used at low temperatures because of the danger of breakage, and cannot be used at high temperatures because the polymer crystallizes, which causes the optical clarity to diminish.

Polycarbonate sheets can be used in applications where a low temperature impact strength is needed, or a high service temperature is required. In this regard, polycarbonate sheets have high impact strengths at low temperatures, as well as, a high T_{g} that allows them to be used in high temperature applications. However, polycarbonate has poor solvent resistance, thereby limiting its use in certain applications, and is prone to stress induced cracking. Polycarbonate sheets also provide greater impact strength than is needed for certain applications, making them costly and inefficient for use.

The polyesters of the present invention can be formed into sheets by any one of the above methods; any other method known in the art; or directly from the polymerization melt. In the alternative, the polyester melt can be formed into an easily handled shape (such as pellets) that can then be used to form a sheet. The sheet of the present invention can be used, for example, in forming signs; in forming glazings, such as in bus stop shelters, sky lights or recreational vehicles; in forming displays; in forming automobile lights; and in thermoforming articles.

A sheet can be produced from the polyesters of the present invention by any process known in the art. The difference between a sheet and a film is the thickness, but there is no set industry standard as to when a film becomes a sheet. For purposes of this invention, a sheet is greater than about 0.25 mm (10 mils) thick, preferably between about 0.25 mm and 25 mm, more preferably from about 2 mm to about 15 mm, and even more preferably from about 3 mm to about 10 mm. In a preferred embodiment, the sheet of the present invention is thick enough to enable the sheet to be rigid, which generally occurs at a thickness of about 0.50 mm and more. Sheets thicker than 25 mm, and thinner than 0.25 mm, however, can be formed.

Sheets can be formed by any process known in the art, such as, for example, an extrusion, solution casting or injection molding process. One of ordinary skill in the art can easily determine the parameters for each process by reviewing the viscosity characteristics of the polyester and the desired thickness of the sheet.

The sheet of the present invention is preferably formed by either solution casting or extrusion. Extrusion is particularly preferred for formation of “endless”00 products, such as films and sheets, which emerge as a continuous length. WO 96/38282 and WO 97/00284, for example, disclose the formation of crystallizable sheets by melt extrusion.

In extrusion, the polymeric material, whether provided as a molten polymer or as plastic pellets or granules, is fluidized and homogenized. The mixture is then forced through a suitably shaped die to produce the desired cross-sectional sheet shape. The extruding force can be exerted by a piston or ram (ram extrusion), or a rotating screw (screw extrusion) in the cylinder in which the molten polymer is heated and plasticized, wherein the molten polymer is extruded from the cylinder through the die in a continuous flow. Single screw, twin screw, and multi-screw extruders known in the art can be used. Different kinds of die can be used to produce different products. For example, slot dies are used to produce sheets and strips, and circular dies are used to produce hollow and solid sections. As a result, sheets of differing widths and thicknesses can be produced. After extrusion, the polymeric sheet is taken up on rollers, cooled, and then taken off by a device designed to prevent any subsequent deformation of the sheet.

Using extruders as known in the art, a sheet can be produced by extruding a thin layer of polymer over chilled rolls, and then further drawing down the sheet to size (>0.25 mm) by tension rolls. Preferably, the finished sheet is greater than 0.25 mm thick.

A sheeting calender can be used to manufacture large quantities of sheets. A calender is a machine comprising a number of heatable parallel cylindrical rollers that rotate in opposite directions, wherein the rollers spread out and stretch the polymer to the required thickness. A rough film is fed into the gap of the calender and is spread out and stretched to the required thickness, wherein the last roller smoothes the sheet that is produced. If the sheet, however, is required to have a textured surface, the final roller is embossed with a pattern. Alternatively, the sheet can be reheated and passed through an embossing calender. The calender is followed by one or more cooling drums. Finally, the finished sheet is reeled up.

The above extrusion process can be combined with a variety of post-extruding operations for expanded versatility. Such post-extruding operations include, for example, changing round shapes to oval shapes; stretching a sheet to different dimensions; machining and punching; and biaxially stretching as is known to those skilled in the art.

The polymeric sheet of the invention can be combined with at least one other polymeric material during extrusion and/or finishing to form laminates or multilayer sheets having improved characteristics, such as, for example, water vapor resistance. In particular, the at least one other polymeric material can include, for example, poly(ethylene terephthalate) (PET); aramid; polyethylene sulfide (PES); polyphenylene sulfide (PPS); polyimide (PI); polyethylene imine (PEI); poly(ethylene naphthalate) (PEN); polysulfone (PS); polyether ether ketone (PEEK); olefins; polyethylene; poly(cyclic olefins); cellulose; cyclohexylene dimethylene terephthalate; and the non-limiting list of blendable polymeric materials already set forth hereinabove. A multilayer or laminate sheet can be made by any method known in the art, and can have as many as five or more separate layers joined together by heat, an adhesive and/or a tie layer.

A sheet can also be made by solution casting, which consistently produces a more uniformly gauged sheet than melt extrusion. Solution casting involves dissolving polymeric granules, powder or the like in a suitable solvent with any desired formulant, such as a plasticizer or colorant. The solution is filtered to remove dirt or large particles, and then cast from a slot die onto a moving belt, preferably of stainless steel, dried, whereon the sheet cools. The extrudate thickness is five to ten times that of the finished sheet. The solution cast sheet can then be finished in a manner similar to the manner in which an extruded sheet is finished.

Further, sheets and sheet-like articles, such as discs, can be formed via any injection molding method known in the art.

One of ordinary skill in the art can, based on the polymeric composition and process being used to form the sheet, identify the appropriate process parameters.

Regardless of how the sheet is formed, it can be subjected to biaxial orientation by being stretched in both the machine and transverse directions after being formed. As the film is being formed, it can be stretched in the machine direction simply by being rolled out and taken up. Although stretching the film in the direction of takeup will orient some of the fibers and strengthen the film in the machine direction, the film can still be easily torn in the direction at right angles because all of the fibers are oriented in the same direction.

Therefore, biaxially stretched sheets are preferred for certain uses where uniform sheeting is desired. Biaxial stretching orients the fibers parallel to the plane of the sheet, but leaves the fibers in the plane of the sheet randomly oriented. Biaxially oriented sheets, for example, have superior tensile strength; flexibility; toughness; and shrinkability in comparison to non-oriented sheets. Preferably, the sheet is stretched along two axes at right angles to each other, thereby increasing tensile strength and elastic modulus in the directions of stretch. Preferably, the amount of stretch in each direction is roughly equivalent so that the film will have similar properties or behaviors when tested from any direction.

While any process known in the art can be used to biaxially orient a sheet, tentering is preferred. In tentering, a polymeric sheet is being heated as it is stretched in the transverse direction simultaneously with, or subsequent to, being stretched in the machine direction.

Shrinkage can be controlled by holding the sheet in a stretched position and heating for a few seconds before quenching. The heat stabilizes the oriented sheet against shrinkage at temperatures below the heat stabilization temperature.

A person of ordinary skill in the art can readily determine the process conditions and parameters of any art known process used to make a sheet from any given polymeric composition and for any desired application.

The properties exhibited by a sheet will depend on the factors already indicated hereinabove, including, but not limited to polymeric composition; method of forming the polymer; method of forming the sheet; and whether the sheet was treated for stretch or biaxially oriented. Such factors affect many properties of the sheet, such as, for example, shrinkage; tensile strength; elongation at break; impact strength; dielectric strength and constant; tensile modulus; chemical resistance; melting point; and heat deflection temperature.

Sheet properties can be further adjusted by adding certain additives and fillers to the polymeric composition, wherein a non-limiting list of acceptable additives and fillers is already set forth hereinabove. Alternatively, the polyesters of the present invention can be blended with at least one other polymer to improve the characteristics already recited hereinabove. For example, at least one other polymer can be added to change such characteristics as air permeability, optical clarity, strength and/or elasticity.

The sheets of the present invention can be thermoformed via any known method into any desirable shape, such as, for example, covers; skylights; shaped greenhouse glazings; displays; and food trays. A sheet is thermoformed by being heated to a sufficient temperature for a sufficient amount of time to soften the polyester sheet enough so that it can be easily molded into the desired shape. One of ordinary skill in the art can easily determine the optimal thermoforming parameters by noting the viscosity and crystallization characteristics of the polyester sheet.

The polyesters of the present invention can also be used to make plastic containers. The wollastonite reinforcing filler contained in the polyesters produced in accordance with the process of the present invention provides enhanced strength, abrasion resistance, stiffness, and other benefits to the containers produced therefrom. Plastic containers are widely used for foods and beverages, and also for non-food materials. Poly(ethylene terephthalate) (PET) is used to make many of these containers because of its appearance (optical clarity), ease of blow molding, chemical and thermal stability, and price. PET is generally fabricated into bottles by blow molding processes, and more particularly by stretch blow molding processes. Containers produced from carbon black containing polyesters produced in accordance with the process of the present invention can be used in laser marking for identification purposes. In addition, the very low levels of carbon black, such as, for example, in the 5-25 ppm range, contained in such polyesters can function as reheat catalysts in the stretch blow molding process as the preform is heated to form the final container, such as a soda bottle.

In stretch blow molding, PET is first shaped by injection molding into a thick-walled preformed parison (a “preform”) that is typically in the shape of a tube with a threaded opening at the top. The parison can be cooled and either used later in a subsequent step, or the process can be carried out in one machine with cooling just to the stretch blow molding temperature. In the stretch blow molding step, the parison is heated in the mold to a high enough temperature to allow shaping, but not so high that the parison crystallizes or melts (i.e., just above the T_{g}). The parison is expanded to fill the mold by rapidly being stretched via mechanical means in the axial direction (e.g., by using a mandrel) while simultaneously being radially expanded by having air forced under pressure into the heated parison. The PET used in blow molding is typically modified with a small amount of comonomer, usually 1,4-cyclohexanedimethanol or isophthalic acid, to increase the temperature at which PET can be successfully blow molded to about 9° C. The comonomer is necessary because of the need for a wider PET blow molding temperature window, and also to decrease the rate of stress induced crystallization. At the same time, however, the comonomer can have the undesirable effect of lowering the T_{g} and reducing the crystallinity of PET. Stretch blow molding of PET, and blow molding processes in general, are well known in the art. Reviews are widely available, as for example, “Blow Molding” by C. Irwin in Encyclopedia of Polymer Science And Engineering, Second Edition, Vol. 2, John Wiley and Sons, New York, 1985, pp. 447-478.

The containers described herein can be made by any method known in the art, such as extrusion, injection molding, injection blow molding, rotational molding, thermoforming of a sheet, and stretch-blow molding.

Preferably, the containers of the present invention are made via stretch-blow molding, which is generally used in the production of PET containers, such as bottles. In this case, any of the cold parison methods can be used, wherein a preformed parison (generally made by injection molding) is taken out of the mold and then subjected to stretch blow molding in a separate step. The hot parison method as known in the art can also be used, wherein the injection molded parison, without completely being cooled, is immediately subjected to stretch blow molding in the same equipment used to injection mold the parison. The parison temperature will vary based on the exact composition of the polymer used. Generally, parison temperatures in the range of from about 90 to about 160° C. are useful. The stretch blow molding temperature will also vary depending on the exact material composition used, but a mold temperature of about 80 to about 150° C. is generally useful.

The containers of the invention can take any shape, but particularly include narrow-mouth and wide-mouth bottles having threaded tops and a volume of about 400 mL to about 3 liters, although smaller and larger containers can be formed. The containers can be used in standard cold fill and hot fill applications. Such containers are suitable for foods and beverages, and other solids and liquids. The containers are normally clear and transparent, but can be modified to have color or be opaque by either adding colorants or dyes, or causing crystallization of the polymer, wherein crystallization results in opaqueness.

Polyesters formed in accordance with the process of the present invention can also be used to produce fibers. The wollastonite reinforcing filler contained in such polyesters provides enhanced strength, abrasion resistance, stiffness, and other benefits to such fibers. Polyester fibers are generally produced in large quantities for a variety of applications. Such fibers are generally used in textiles, particularly in combination with natural fibers such as, for example, cotton and wool. Clothing, rugs, and other items can be fashioned from such fibers. Polyester fibers are desirably used in industrial applications due to the elasticity and strength of such fibers. In particular, polyester fibers are used to make articles such as, for example, tire cords and ropes.

The carbon black containing polyesters formed in accordance with the process of the present invention produce fibers covering the entire range of electrical properties, including, for example, antistatic; static dissipating or moderately conductive; and conductive. For example, fibers produced from carbon black containing polyesters can be antistatic and antisoiling. A fiber can take many forms, such as, for example, a homogeneous or bicomponent fiber. The polyesters of the present invention can also serve as a conductive core that is covered by dielectric sheath material. In comparison to the materials available in the art, the carbon black containing polyesters of the present invention advantageously retain a majority of their physical properties due to the relatively low level of carbon black needed to provide fibers produced therefrom with the desired electrical properties. The antistatic fibers produced from the carbon black containing polyesters of the present invention are capable of providing antistatic protection to all types of textile end uses, including, for example, knitted, tufted, woven, and nonwoven textiles. Antistatic monofilaments can be used as hairbrushes, especially in low humidity environments, and can be woven into fabric that is used as belting materials in, for example, paper production; clothing; poultry belts; and package conveyance belts.

As is well known, static electricity can be generated and transferred by walking across a conventional carpet made of hydrophobic fiber materials, such as, for example, nylon fiber; acrylic fiber; polypropylene fiber; and polyester fiber. Upon becoming grounded by, for example touching a doorknob or metal cabinet, an electrical shock exceeding 3500 volts can be delivered. Such a shock is quite annoying and can provide significant discomfort to the recipient. The carbon black contained in the polyesters used to make the fibers of the present invention, however, can provide antistatic protection to such carpet structures. The accumulation of static electricity in textiles is not only an annoyance, such as occurs with, for example, carpeting; static cling, i.e. items of apparel clinging to the body and other garments, especially as occurs with hospital gowns and garments; and fine particles of lint and dust being attracted to and gathering on upholstery fabrics increasing the frequency of required cleaning, but can also constitute a real danger, such as, for example, flammable materials commonly found in hospitals being ignited by a spark caused by the discharge of static electricity. The antistatic materials of the present invention, however, reduce such dangers.

The term “fibers” as used herein includes continuous monofilaments; non-twisted or entangled multifilament yarns; staple yarns; spun yarns; melt blown fibers; non-woven materials; and melt blown non-woven materials. Such fibers can be used to form uneven fabrics; knitted fabrics; fabric webs; or any other fiber-containing structures, such as tire cords.

Synthetic fibers, such as, for example, nylon, acrylic, polyester, and others, are made by spinning and drawing a polymer into a filament that is then wound with other filaments to produce yarn. The fibers are often treated mechanically and/or chemically to impart desirable characteristics such as, for example, strength, elasticity, heat resistance, and hand (feel of fabric), wherein such desirable characteristics are known in the art and will depend on the end product being fashioned from the fibers.

The monomer composition of the polyester of the present invention is desirably chosen so as to result in a partially crystalline polymer. Crystallinity is desired to provide strength and elasticity to the fibers being formed. As first produced, the polyester is mostly amorphous in structure. In preferred embodiments, the polyester polymer readily crystallizes on reheating and/or extension of the polymer.

The fibers of the present invention are made in accordance with any process known in the art. Polyester fibers, however, are preferably made via a melt spinning process.

Melt spinning, which is commonly used for polyesters such as PET, involves heating the polymer to form a molten liquid, or melting the polymer against a heated surface, wherein the molten/melted polymer is then forced through a spinneret with a plurality of fine holes. After passing through the spinneret, the molten polymer comes into contact with either air, or a non-reactive gas stream solidifying into filaments. A convergence guide located downstream from the spinneret gathers the filaments together, and a roller or plurality of rollers takes up the filaments. Such a process allows filaments of various sizes and cross sections to be formed, including filaments having, for example, a round; elliptical; square; rectangular; and lobed or dog-boned cross section.

After the extrusion and uptake of a fiber, the fiber is usually drawn. Drawing the fiber increases crystallization, as well as, maximizes desirable properties such as, for example, orientation along the longitudinal axis, which increases elasticity, and strength. The drawing can be done in combination with take-up by using a series of rollers, some of which are generally heated, as known in the art, or may be done as a separate stage in the process of fiber formation.

The polymer can be spun at speeds of from about 600 to 6000 meters/minute or higher, depending on the desired fiber size. For textile applications, the fiber should be from about 0.1 to about 100 denier/filament, preferably from about 0.5 to about 20, and more preferably from about 0.7 to about 10. For industrial applications, however, the fiber should be from about 0.5 to about 100 denier/filament, preferably from about 1.0 to about 10.0, and more preferably from about 3.0 to about 5.0. The required size and strength of a fiber for any given application can readily be determined by one of ordinary skill in the art.

The resulting filamentary material is amenable to further processing through the use of additional processing equipment, or can be used directly in applications requiring a continuous filament textile yarn. If desired, the filamentary material can be converted from a flat yarn to a textured yarn through known false twist texturing conditions or other processes known in the art. In particular, fibers having a softer feel and enhanced breathability can be produced by increasing the surface area of the fiber, wherein such fibers can be used to produce textiles having for example, better insulation and water retention. The fibers can be crimped or twisted by, for example, the false twist method; air jet method; edge crimp method; gear crimp method; or stuffer box method. Alternatively, the fibers can be cut into shorter lengths, which is called staple, and then processed into yarn. A skilled artisan can determine the best method of crimping or twisting based on the desired application and the composition of the fiber.

After formation, the fibers can be finished by any method appropriate for the desired end use. In the case of textiles, such methods may include, for example, dyeing; sizing; or adding chemical agents that can adjust the look and hand of the fibers such as, for example, antistatic agents, flame retardants, UV light stabilizers, antioxidants, pigments, dyes, stain resisting agents, and antimicrobial agents. For industrial applications, fibers can be treated to impart additional characteristics such as, for example, strength, elasticity, or shrinkage.

The continuous filament fiber of the invention can be used either as produced or texturized for use in a variety of applications such as, for example, textile fabrics for apparel and home furnishings. High tenacity fiber can be used in industrial applications such as, for example, high strength fabrics; tarpaulins; sail cloth; sewing threads; and rubber reinforcement for tires and V-belts.

The staple fiber of the invention can be used to form a blend with natural fibers, especially cotton and wool In particular, polyester is a chemically resistant fiber that is generally resistant to mold, mildew, and other problems inherent to natural fibers. Polyester fibers provide strength and abrasion resistance to such blended material, as well as, provide a lower costing material. As a result, polyester fibers are ideally used in textiles and other commercial applications, such as, for example, fabrics for apparel; home furnishings; and carpets.

Further, the polyester produced in accordance with the process of the present invention can be used with other synthetic or natural polymers to produce a heterogeneous fiber having improved properties. A heterogeneous fiber can be formed in any suitable manner known in the art, such as, for example, side-by-side; sheath-core; and matrix designs.

A further aspect of the present invention includes monofilaments produced from the wollastonite containing polyesters of the present invention, wherein such monofilaments have enhanced abrasion resistance, stiffness, and strength. The wollastonite reinforcing filler, as described above, can be added to the polyester by any known method, such as intensive melt mixing through, for example, extrusion compounding, as described above.

For some enduses, such as monofilaments, the polyesters of the present invention can be stabilized against hydrolytic degradation by adding an effective amount of hydrolysis stabilization additive. A hydrolysis stabilization additive chemically reacts with carboxylic acid endgroups.

The hydrolysis stabilization additive can be any material known in the art to stabilize the polyester monofilament against hydrolytic degradation. Examples of hydrolysis stabilization additives, include, for example, diazomethane; carbodiimides; epoxides; cyclic carbonates; oxazolines; aziridines; keteneimines; isocyanates; and alkoxy end-capped polyalkylene glycols. This should not be considered limiting as essentially any material that increases the hydrolytic stability of monofilaments made from the polyesters of the present invention may be used as a hydrolysis stabilization additive.

Preferably, carbodiimides are selected from N,N′-di-o-tolylcarbodiimide; N,N′-diphenylcarbodiimide; N,N′dioctyldecylcarbodiimide; N,N′-di-2,6-dimethylphenylcarbodiimide; N-tolyl-N′cyclohexylcarbodiimide; N,N′-di-2,6-diisopropylphenylcarbodiimide; N,N′di-2,6-di-tert-butylphenylcarbodiimide; N-tolyl-N′-phenylcarbodiimide; N,N′-di-p-nitrophenylcarbodiimide; N,N′di-p-aminophenylcarbodiimide; N,N′-di-p-hydroxyphenylcarbodiimide; N,N′-di-cyclohexylcarbodiimide; N,N′-di-p-tolylcarbodiimide; p-phenylene-bis-di-o-tolylcarbodiimide; p-phenylene-bisdicyclohexylcarbodiimide; hexamethylene-bisdicyclohexylcarbodiimide; ethylene-bisdiphenylcarbodiimide; benzene-2,4-diisocyanato-1,3,5-tris(1-methylethyl) homopolymer; and a copolymer of 2,4-diisocyanato-1,3,5-tris(10methylethyl) with 2,6-diisoproyl diisocyanate. Such materials are commercially sold by Rhein-Chemie of Rheinau GmbH, Germany and Bayer under the tradenames STABAXOL 1, STABAXOL P, STABAXOL P-100, and STABAXOL KE7646. U.S. Pat. Nos. 3,193,522; 3,193,523; 3,975,329; 5,169,499; 5,169,711; 5,246,992; 5,378,537; 5,464,890; 5,686,552; 5,763,538; 5,885,709; and 5,886,088 disclose the use of carbodiimides as hydrolysis stabilization additives.

Preferably, the epoxides are selected from iso-nonyl-glycidyl ether; stearyl glycidyl ether; tricyclo-decylmethylene glycidyl ether; phenyl glycidyl ether; p-tert.-butylphenyl glycidyl ether; o-decylphenyl glycidyl ether; allyl glycidyl ether; butyl glycidyl ether; lauryl glycidyl ether; benzyl glycidyl ether; cyclohexyl glycidyl ether; alpha-cresyl glycidyl ether; decyl glycidyl ether; dodecyl glycidyl ether; N-(epoxyethyl)succinimide; and N-(2,3-epoxypropyl)phthalimide. Catalysts such as, for example, alkali metal salts can be included to increase the rate of reaction. U.S. Pat. Nos. 3,627,867; 3,657,191; 3,869,427; 4,016,142; 4,071,504; 4,139,521; 4,144,285; 4,374,960; 4,520,174; 4,520,175; 5,763,538; and 5,886,088 disclose the use of epoxides as hydrolysis stabilization additives.

Preferably, the cyclic carbonates are selected from ethylene carbonate; methyl ethylene carbonate; 1,1,2,2-tetramethyl ethylene carbonate; and 1,2-diphenyl ethylene carbonate. Cyclic carbonates, such as ethylene carbonate, are disclosed as hydrolysis stabilization additives in U.S. Pat. Nos. 3,657,191; 4,374,960; and 4,374,961.

Preferably, the hydrolysis stabilization additive is a carbodiimide.

The effective amount of hydrolysis stabilization additive is the amount of additive that needs to be added to the polyester to lower the carboxyl concentration of the polyester during its conversion to monofilaments, and will depend on the carboxyl content of the polyester prior to being extruded into monofilaments. In general, the amount of hydrolysis stabilization additive ranges from about 0.1 to about 10.0 weight percent based on the polyester, and preferably from about 0.2 to about 4.0 weight percent.

The hydrolysis stabilization additive can be added to the polyesters of the present invention through a separate melt compounding process utilizing any known intensive mixing process, such as, for example, extrusion through a single screw or twin screw extruder; intimate mixing with a solid granular material, such as, for example, mixing, stirring or pellet blending operations; or cofeeding in the monofilament process. Preferably, the hydrolysis additive is added via cofeeding in the monofilament process.

The polyesters of the present invention can be formed into monofilaments by any known method in the art, such as, for example, is disclosed in U.S. Pat. No. 3,051,212, U.S. Pat. No. 3,999,910, U.S. Pat. No. 4,024,698, U.S. Pat. No. 4,030,651, U.S. Pat. No. 4,072,457, and U.S. Pat. No. 4,072,663. A person of ordinary skill in the art can appreciate that the process can be tailored to take into account the exact material being formed into monofilaments, as well as, the physical and chemical properties that the monofilament being formed is desire to have. The spinning parameters needed to obtain a monofilament having a specific combination of properties can be determined by determining the dependence of the contemplated monofilament property on the composition of the polyester and the spinning parameters.

The polyesters of the present invention are preferably dried prior to being formed into a monofilament. In general, the polyesters of the present invention can be melted at a temperature ranging from about 100° to about 300° C., and preferably ranging from about 150° to about 290° C. Generally, spinning can be carried out by means of a spinning grid or an extruder. An extruder melts the dried granular polyesters of the present invention, and then conveys the melt to the spinning aggregate by means of a screw. It is well known that a polyester tends to thermally degrade depending on the time spent in, and temperature of, the polyester melt. The time the polyester spends in the melt can be minimized by using the shortest length of pipe to convey the melted polyester to the spinneret. The molten polyester can be filtered through, for example, screen filters, to remove any particulate foreign matter. The molten polyester can then be conveyed, optionally through a metering pump, to a die to form the monofilament. After exiting the die, the monofilament can be quenched in an air or a water bath to form the solid filaments. The monofilament can optionally be spin finished. The filaments can then be drawn at elevated temperatures of up to 100° C. between a set of draw rolls to a draw ratio of from 3.0:1 to 4.5:1, and can optionally be further drawn at a higher temperature of up to 250° C. to a maximum draw ratio of 6.5:1. After drawing is complete, the filaments are allowed to relax up to about 30 percent maximum while heated in a relaxed stage. The finished cooled monofilaments can then be wound up onto spools. This should not be considered limiting as the polyesters of the present invention can be formed into the shape of monofilaments by any known process for producing monofilaments.

To provide the desired tenacity, the filaments prepared from the polyesters of the present invention can have a draw ratio of at least about 2:1, preferably at least about 4:1. The overall draw ratio can be varied to allow monofilaments having a range of denier to be produced.

Typically, monofilaments used in press fabrics and dryer fabrics have a size ranging from about 0.20 mm to about 1.27 mm in diameter or the equivalent mass in cross-section in other cross-sectional shapes, such as square or oval. For forming fabrics, finer monofilaments are used, for example, as small as about 0.05 mm to about 0.9 mm in diameter. Most often, the monofilaments used in forming fabrics have a diameter between about 0.12 mm to about 0.4 mm. On the other hand, for special industrial applications, monofilaments of 3.8 mm in diameter or greater can be desired.

The monofilament of the present invention can take any cross-sectional shape, such as, for example, a circle; flattened figure; square; triangle; pentagon; polygon; multifoil; dumbbell; and cocoon. When a monofilament is used as a warp in a papermaking drier canvas, the monofilament with a cross-sectional shape of a flattened figure is preferably used to improve the level of proof against staining, and to ensure that a flat drier canvas is produced. The term “flattened figure” as used herein refers to an ellipse or a rectangle. The term not only embraces a geometrically defined exact ellipse and rectangle, but also shapes roughly similar to an ellipse and a rectangle, including the shape obtained by rounding the four corners of a rectangle.

Monofilaments can further be woven into textile fabrics through typical art processes.

The polyesters of the present invention can also be formed into shaped foamed articles. Thermoplastic polymeric materials are foamed to provide low density articles, such as, for example, films; cups; food trays; decorative ribbons; and furniture parts. For example, polystyrene beads containing low boiling hydrocarbons, such as pentane, are formed into light weight foamed cups for hot drinks such as coffee, tea, and hot chocolate. Polypropylene can be extruded in the presence of blowing agents such as, for example, nitrogen or carbon dioxide gas to provide decorative films and ribbons for package wrappings. Polypropylene can also be injection molded in the presence of blowing agents to provide lightweight furniture parts, such as, for example, table legs and lightweight chairs.

Polyesters, such as PET, typically have a much higher density (e.g. 1.3 g/cc) than other polymers. Producing a foam polyester material is, therefore, desired to decrease the weight of, for example, molded parts; films; sheets; food trays; and thermoformed parts. A foamed article also has better insulating properties than an unfoamed article.

In general, the polyester being foamed should have a high melt viscosity. A sufficiently high melt viscosity is needed to enable the foamed article that is being formed to hold its shape long enough for the polyester to solidify. A sufficiently high melt viscosity can be achieved by raising the IV of the polyester being produced through post-polymerization processes, such as, for example, the solid state polymerization method already described hereinabove. Alternatively, a branching agent can be incorporated into the polyester, such as described, for example in U.S. Pat. Nos. 4,132,707; 4,145,466; 4,999,388; 5,000,991; 5,110,844; 5,128,383; and 5,134,028. A branched polyester can be further subjected to solid state polymerization, as already described above, to further enhance melt viscosity. In addition, incorporating sulfonate substituents on the polyetherester backbone can raise the apparent melt viscosity of the polyester, thereby providing an adequate foamable polyester.

The polyesters of the present invention can be readily foamed by a wide variety of methods. Such methods include injecting an inert gas such as, for example, nitrogen or carbon dioxide into the melt during the extrusion or molding operations. Alternatively, the inert gas can include, for example, inert hydrocarbon gases such as, for example, methane, ethane, propane, butane, and pentane; chlorofluorocarobons; hydrochlorofluorocarbons; or hydrofluorocarbons. Another method involves dry blending the chemical blowing agents with the polyester, and then extruding or molding the compositions into foamed articles. During the extrusion or molding operation, an inert gas, such as nitrogen is released from the blowing agent, thereby providing the foaming action. Typical blowing agents include, for example, azodicaronamide; hydrazocarbonamide; dinitrosopentamethylenetetramine; p-toluenesulfonyl hydrazodicarboxylate; 5-phenyl-3,6-dihydro-1,3,4-oxa-diazin-2-one; sodium borohydride; sodium bicarbonate; and 5-phenyltetrazole, p,p′-oxybis(benzenesulfonylhydrazide). Still another method involves blending one polyester pellet portion with sodium carbonate or sodium bicarbonate, and then blending another polyester pellet portion with an organic acid, such as citric acid, wherein the two polyester pellet portions are subsequently blended together at elevated temperatures via an extrusion or molding process. The carbon dioxide gas that is released as a result of the interaction of the sodium carbonate and citric acid provides the desired foaming action.

Preferably, the foamable polyester compositions incorporate nucleation agents to create sites for bubble initiation; influence the cell size of the foamed sheet or object; and hasten the solidification of the foamed article being formed. Suitable nucleation agents include, for example, sodium acetate; talc; titanium dioxide; and polyolefin materials, such as polyethylene and polypropylene.

Polymeric foaming equipment and processes are generally known. See, for example, U.S. Pat. No. 5,116,881; U.S. Pat. No. 5,134,028; U.S. Pat. No. 4,626,183; U.S. Pat. No. 5,128,383; U.S. Pat. No. 4,746,478; U.S. Pat. No. 5,110,844; U.S. Pat. No. 5,000,844; and U.S. Pat. No. 4,761,256. Additional foaming technology information can be found in Kirk-Othmer Encyclopedia of Chemical Technology, Third Edition, Volume 11, pp. 82-145 (1980), John Wiley and Sons, Inc., New York, N.Y.; and the Encyclopedia of Polymer Science and Engineering, Second Edition, Volume 2, pp. 434-446 (1985), John Wiley and Sons, Inc., New York, N.Y.

The foamable polyester compositions can also include a wide variety of additives, fillers, or be blended with other materials, wherein a non-limiting list of such fillers, additives and other blendable materials has already been set forth hereinabove.

### EXAMPLES AND COMPARATIVE EXAMPLES

Test Methods

Differential Scanning Calorimetry (DSC) was performed on a TA Instruments Model Number 2920 machine. Samples were heated under a nitrogen atmosphere to 300° C. at a rate of 20° C./minute, programmed cooled back to room temperature at a rate of 20° C./minute and then reheated to 300° C. at a rate of 20° C./minute. The observed glass transition temperature (T_{g}) and crystalline melting temperature (Tₘ) were recorded from the second heat.

Inherent Viscosity (IV) is defined in “Preparative Methods of Polymer Chemistry”, W. R. Sorenson and T. W. Campbell, 1961, p. 35. The IV was determined at a concentration of 0.5 g/100 mL of a 50:50 weight percent trifluoroacetic acid:dichloromethane acid solvent system at room temperature by a Goodyear R-103B method.

Laboratory Relative Viscosity (LRV) is the ratio of the viscosity of a solution of a 0.6 gram polyester sample dissolved in 10 mL of hexafluoroisopropanol (HFIP) containing 80 ppm sulfuric acid to the viscosity of a sulfuric acid-containing hexafluoroisopropanol, wherein the LRV of both were measured at 25° C. in a capillary viscometer. In some instances, the LRV may be numerically related to the IV in such a way that the IV can be calculated from the LRV, wherein an IV determined in such manner is called the “calculated IV”.

Surface resistivity was measured with a T Rex Model Number 152 CE Resistance Meter from T Rek, Inc. at a 10 volt test voltage. As the meter cannot measure surface resitivities that are less than 10³ Ohms per square, surface resistivity readings of 10³ Ohms per square may actually be less than 10³Ohms per square.

### Example 1

To a 250 mL glass flask was added 177.97 gm bis(2-hydroxyethyl)terephthalate, 1.36 gm Nyglos® MFH18, 0.0600 gm manganese(II) acetate tetrahydrate, and 0.0484 gm antimony(III) trioxide. The reaction mixture was stirred and heated to 180° C. under a slow nitrogen purge. After achieving 180° C., the reaction mixture was stirred at 180° C. for 0.2 hours while under a slow nitrogen purge. The reaction mixture continued to be stirred under a slow nitrogen purge while being heated over 0.3 hours to 225° C. After achieving 225° C., the reaction mixture was stirred at 225° C. for 0.6 hours while under a slow nitrogen purge. The reaction mixture continued to be stirred under a slow nitrogen purge while being heated over 0.5 hours to 285° C. After reaching 285° C., the reaction mixture was stirred at 285° C. for 1.4 hours while under a slight nitrogen purge. During the heating cycle, 23.5 gm of colorless distillate was collected. The reaction mixture was then staged to full vacuum with stirring at 285° C. The resulting reaction mixture was stirred for 1.4 hours under full vacuum (pressure less than 100 mtorr). The vacuum was released with nitrogen, and the reaction mass was allowed to cool to room temperature. 114.0 gm of solid product, as well as, an additional 17.3 gm of distillate were recovered.

The solid product was found to have an LRV of 16.11 and a calculated IV of 0.54 dL/g. DSC analysis revealed a recrystallization temperature on the programmed cool after the first heat cycle with a peak of 194.8° C.; a T_{g} with an onset of 73.60° C., a midpoint of 80.5° C., and an endpoint of 87.5° C.; and a Tₘ observed to be at 253.0° C. (36.9 J/g).

### Example 2

To a 250 mL glass flask was added 116.51 gm dimethyl terephthalate, 73.06 gm 1,3-propanediol, 1.25 gm Nyglos® MFH18, 0.0551 gm manganese(II) acetate tetrahydrate, and 0.0447 gm antimony(III) trioxide. The reaction mixture was stirred and heated to 180° C. under a slow nitrogen purge. After achieving 180° C., the reaction mixture was stirred at 180° C. for 0.3 hours while under a slow nitrogen purge. The reaction mixture was stirred under a slow nitrogen purge while being heated over 0.2 hours to 190° C. After achieving 190° C., the reaction mixture was stirred at 190°C. for 0.4 hours while under a slow nitrogen purge. The reaction mixture was stirred under a slow nitrogen purge while being heated over 0.1 hours to 200° C. After achieving 200° C., the reaction mixture was stirred at 200° C. for 0.6 hours while under a slow nitrogen purge. The reaction mixture was then stirred under a slow nitrogen purge while being heated over 0.2 hours to 225° C. After achieving 250° C., the reaction mixture was stirred at 250° C. for 0.9 hours while under a slow nitrogen purge. The reaction mixture was heated to 255° C. over 0.2 hours with stirring under a slow nitrogen purge. After achieving 255° C., the reaction mixture was stirred at 255° C. for 0.7 hours while under a slight nitrogen purge. During the heating cycle, 31.6 grams of colorless distillate was collected. The reaction mixture was then staged to full vacuum with stirring at 255° C. The resulting reaction mixture was stirred for 3.4 hours under full vacuum (pressure less than 100 mtorr). The vacuum was released with nitrogen, and the reaction mass was allowed to cool to room temperature. 112.2 gm of solid product, as well as, an additional 19.4 gm of distillate were recovered.

The solid product was found to have an LRV of 21.70 and a calculated IV of 0.64 dL/g. DSC analysis revealed a recrystallization temperature on the programmed cool after the first heat cycle with an onset of 187.0° C. and a peak of 162.8° C. (48.4 J/g); and a Tₘ observed to be at 229.9° C. (49.5 J/g).

### Example 3

To a 250 mL glass flask was added 87.39 gm dimethyl terephthalate, 52.72 gm 1,4-butanediol, 1.00 gm Nyglos® 4, and 0.1170 gm titanium(IV) isopropoxide. The reaction mixture was stirred and heated to 180° C. under a slow nitrogen purge. After achieving 180° C., the reaction mixture was stirred at 180° C. for 0.5 hours while under a slow nitrogen purge. The reaction mixture was stirred under a slow nitrogen purge while being heated over 0.2 hours eated to 190° C. After achieving 190° C., the reaction mixture was stirred at 190° C. for 0.6 hours while under a slow nitrogen purge. The reaction mixture was stirred under a slow nitrogen purge while being heated over 0.3 hours to 200° C. After achieving 200° C., the reaction mixture was stirred at 200° C. for 0.5 hours while under a slow nitrogen purge. The reaction mixture was again stirred under a slow nitrogen purge while being heated over 0.2 hours to 250° C. After achieving 250° C., the reaction mixture was stirred at 225° C. for 0.5 hours while under a slow nitrogen purge. The reaction mixture was again stirred under a slow nitrogen purge while being heated over 0.5 hours to 255° C. After obtaining 255° C., the reaction mixture was stirred at 255° C. under a slight nitrogen purge for 0.5 hours. During the heating cycle, 22.4 gm of colorless distillate was collected. The reaction mixture was then staged to full vacuum with stirring at 255° C. The resulting reaction mixture was stirred for 1.6 hours under full vacuum (pressure less than 100 mtorr). The vacuum was released with nitrogen, and the reaction mass was allowed to cool to room temperature. 95.9 gm of solid product, as well as, an additional 4.6 gm of distillate were recovered.

The solid product was found to have an LRV of 32.87 and a calculated IV of 0.84 dL/g. DSC analysis revealed a recrystallization temperature on the programmed cool after the first heat cycle with an onset of 196.5° C. and a peak of 190.7° C. (53.1 J/g); a T_{g} with an onset of 42.2° C., a midpoint of 45.3° C., and an endpoint of 48.4° C.; and a Tₘ observed to be at 226.9° C. (48.3 J/g).

### Example 4

To a 250 mL glass flask was added 177.97 gm bis(2-hydroxyethyl)terephthalate, 3.45 gm Nyglos® MFH18, 0.0601 gm manganese(II) acetate tetrahydrate, and 0.0487 gm antimony(III) trioxide. The reaction mixture was stirred and heated to 180° C. under a slow nitrogen purge. After achieving 180° C., the resulting reaction mixture was stirred at 180° C. for 0.2 hours while under a slow nitrogen purge. The reaction mixture was then stirred under a slow nitrogen purge while being heated over 0.2 hours to 250° C. After achieving 250° C., the reaction mixture was stirred at 225° C. for 0.9 hours while under a slow nitrogen purge. The reaction mixture was again stirred under a slow nitrogen purge while being heated over 0.5 hours to 285° C. After obtaining 285° C., the reaction mixture was stirred at 285° C. for 0.9 hours while under a slight nitrogen purge. During the heating cycle, 23.4 gm of colorless distillate was collected. The reaction mixture was then staged to full vacuum with stirring at 285° C. The resulting reaction mixture was stirred for 1.1 hours under full vacuum (pressure less than 100 mtorr). The vacuum was released with nitrogen, and the reaction mass was allowed to cool to room temperature. 124.0 gm of solid product, as well as, an additional 21.2 gm of distillate were recovered.

The solid product was found to have an LRV of 17.78 and a calculated IV of 0.57 dL/g. DSC analysis revealed a recrystallization temperature on the programmed cool after the first heat cycle with a peak of 197.5° C.; a T_{g} with an onset of 75.9° C., a midpoint of 80.9° C., and an endpoint of 86.6° C.; and a Tₘ observed to be at 254.3° C. (37.1 J/g).

### Example 5

To a 250 ml glass flask was added 177.97 gm bis(2-hydroxyethyl)terephthalate, 3.45 gm Nyglos® 4, 0.0612 gm manganese(II) acetate tetrahydrate, and 0.0492 gm antimony(III) trioxide. The reaction mixture was stirred and heated to 180° C. under a slow nitrogen purge. After achieving 180° C., the reaction mixture was stirred at 180° C. for 0.2 hours while under a slow nitrogen purge. The reaction mixture was then stirred under a slow nitrogen purge while being heated over 0.6 hours to 225° C. After achieving 225° C., the reaction mixture was stirred at 250° C. for 0.6 hours while under a slow nitrogen purge. The reaction mixture was again stirred under a slow nitrogen purge while being heated over 0.7 hours to 285° C. The reaction mixture was stirred at 285° C. for 0.9 hours while under a slight nitrogen purge. During the heating cycle, 22.8 gm of colorless distillate was collected. The reaction mixture was then staged to full vacuum with stirring at 285° C. The resulting reaction mixture was stirred for 1.3 hours under full vacuum (pressure less than 100 mtorr). The vacuum was released with nitrogen, and the reaction mass was allowed to cool to room temperature. 132.0 gm of a solid product, as well as, an additional 16.9 gm of distillate were recovered.

The solid product was found to have an LRV of 16.68 and a calculated IV of 0.55 dL/g. DSC analysis revealed a recrystallization temperature on the programmed cool after the first heat cycle with an onset of 210.7° C. and a peak of 202.4° C. (41.8 J/g); a T_{g} with an onset of 74.0° C., a midpoint of 78.9° C., and an endpoint of 84.1° C.; and a Tₘ observed to be at 254.8° C. (40.7 J/g).

### Example 6

To a 250 mL glass flask was added 177.97 gm bis(2-hydroxyethyl)terephthalate, 3.45 gm Nyglos® 8, 0.0620 gm manganese(II) acetate tetrahydrate, and 0.0490 gm antimony(III) trioxide. The reaction mixture was stirred and heated to 180° C. under a slow nitrogen purge. After achieving 180° C., the resulting reaction mixture was stirred at 180° C. for 0.4 hours while under a slow nitrogen purge. The reaction mixture was stirred under a slow nitrogen purge while being heated over 0.2 hours to 225° C. After achieving 225° C., the reaction mixture was stirred at 225° C. for 0.7 hours while under a slow nitrogen purge. The reaction mixture was again stirred under a slow nitrogen purge while being heated over 1.2 hours to 285° C. After obtaining 285° C., the reaction mixture was stirred at 285° C. for 1.2 hours while under a slight nitrogen purge. During the heating cycle, 22.2 gm of colorless distillate was collected. The reaction mixture was then staged to full vacuum with stirring at 285° C. The reaction mixture was stirred for 1.3 hours under full vacuum (pressure less than 100 mtorr). The vacuum was released with nitrogen, and the reaction mass was allowed to cool to room temperature. 127.0 gm of a solid product, as well as, an additional 19.5 gm of distillate were recovered.

The solid product was found to have an LRV of 23.04 and a calculated IV of 0.66 dL/g. DSC analysis revealed a recrystallization temperature on the programmed cool after the first heat cycle with an onset of 203.6° C. and a peak of 195.2° C. (41.3 J/g); a T_{g} with an onset of 73.4° C., a midpoint of 78.2° C., and an endpoint of 82.9° C.; and a Tₘ observed to be at 250.7° C. (38.9 J/g).

### Example 7

To a 250 mL glass flask was added 87.00 gm dimethyl terephthalate, 30.00 gm ethylene glycol, 20.80 gm 1,4-cyclohexanedimethanol, 2.54 gm Nyglos® 4, 0.0459 gm manganese(II) acetate tetrahydrate, and 0.0364 gm antimony(III) trioxide. The reaction mixture was stirred and heated to 180° C. under a slow nitrogen purge. After achieving 180° C., the reaction mixture was stirred at 180°C. for 0.5 hours while under a slow nitrogen purge. The reaction mixture was then stirred under a slow nitrogen purge while being heated over 0.1 hours to 190° C. After achieving 190° C., the reaction mixture was stirred at 190° C. for 0.6 hours while under a slow nitrogen purge. The reaction mixture was again stirred under a slow nitrogen purge while being heated over 0.2 hours to 200° C. After achieving 200° C., the reaction mixture was stirred at 200° C. for 2.0 hours while under a slow nitrogen purge. The reaction mixture was again stirred under a slow nitrogen purge while being heated over 0.3 hours to 225° C. After achieving 225° C., the reaction mixture was stirred at 225° C. for 0.5 hours while under a slow nitrogen purge. The reaction mixture was again stirred under a slow nitrogen purge while being heated over 0.7 hours to 295° C. After reaching 295° C., the reaction mixture was stirred at 295° C. for 0.5 hours while under a slight nitrogen purge. During the heating cycle, 14.5 gm of colorless distillate was collected. The reaction mixture was then staged to full vacuum with stirring at 295° C. The reaction mixture was stirred for 2.7 hours under full vacuum (pressure less than 100 mtorr). The vacuum was released with nitrogen, and the reaction mass was allowed to cool to room temperature. 54.7 gm of solid product, as well as, an additional 9.4 gm of distillate were recovered.

The solid product was found to have an LRV of 20.68 and a calculated IV of 0.62 dL/g. DSC analysis revealed a T_{g} with an onset of 78.5° C. and an endpoint of 82.6° C.

### Example 8

To a 250 mL glass flask was added 68.93 gm dimethyl terephthalate, 35.12 gm 1,3-propanediol, 24.38 gm poly(ethylene glycol)-block-poly(propylene glycol)-block-poly(ethylene glycol) (average molecular weight of 1100, 10 wt. % ethylene glycol, CAS Number 9003-11-6), 2.50 grams Nyglos® 4, and 0.1172 grams titanium(IV) isopropoxide. The reaction mixture was stirred and heated to 180° C. under a slow nitrogen purge. After achieving 180° C., the reaction mixture was stirred at 180° C. for 0.4 hours while under a slow nitrogen purge. The reaction mixture was stirred under a slow nitrogen purge while being heated over 0.2 hours to 190° C. After achieving 190° C., the reaction mixture was stirred at 190° C. for 0.5 hours while under a slow nitrogen purge. The reaction mixture was again stirred under a slow nitrogen purge while being heated over 0.3 hours to 200° C. After achieving 200° C., the reaction mixture was stirred at 200° C. for 0.6 hours while under a slow nitrogen purge. The reaction mixture was again stirred under a slow nitrogen purge while being heated over 0.2 hours to 225° C. After achieving 225° C., the resulting reaction mixture was stirred at 225° C. for 0.5 hours while under a slow nitrogen purge. The reaction mixture was again stirred under a slow nitrogen purge while being heated over 0.5 hours to 255° C. After reaching 255° C., the reaction mixture was stirred at 255° C. for 0.5 hours while under a slight nitrogen purge. During the heating cycle, 15.2 gm of colorless distillate was collected. The reaction mixture was then staged to full vacuum with stirring at 255° C. The reaction mixture was stirred for 3.1 hours under full vacuum (pressure less than 100 mtorr). The vacuum was released with nitrogen, and the reaction mass was allowed to cool to room temperature. 85.9 gm of a solid product, as well as, an additional 6.1 gm of distillate were recovered.

The solid product was found to have an LRV of 35.39 and a calculated IV of 0.89 dL/g. DSC analysis revealed a recrystallization temperature on the programmed cool after the first heat cycle with an onset of 179.2° C. and a peak of 170.5° C. (51.1 J/g); and a Tₘ observed to be at 223.0° C. (34.9 J/g).

### Example 9

To a 250 mL glass flask was added 177.97 gm bis(2-hydroxyethyl)terephthalate, 7.07 gm Nyglos® MFH18, 0.0611 gm manganese(II) acetate tetrahydrate, and 0.0498 gm antimony(III) trioxide. The reaction mixture was stirred and heated to 180° C. under a slow nitrogen purge. After achieving 180° C., the reaction mixture was stirred at 180° C. for 0.2 hours while under a slow nitrogen purge. The reaction mixture was then stirred under a slow nitrogen purge while being heated over 0.5 hours to 225° C. After achieving 225° C., the reaction mixture was stirred at 225° C. for 0.5 hours while under a slow nitrogen purge. The reaction mixture was again stirred under a slow nitrogen purge while being heated over 0.9 hours to 285° C. After reaching 285° C., the reaction mixture was stirred at 285° C. for 1.3 hours while under a slight nitrogen purge. During the heating cycle, 25.9 gm of colorless distillate was collected. The reaction mixture was then staged to full vacuum with stirring at 285° C. The resulting reaction mixture was stirred for 1.0 hour under full vacuum (pressure less than 100 mtorr). The vacuum was released with nitrogen, and the reaction mass was allowed to cool to room temperature. 139.0 gm of solid product, as well as, an additional 30.2 gm of distillate were recovered.

The solid product was found to have an LRV of 15.82 and a calculated IV of 0.53 dL/g. DSC analysis revealed a recrystallization temperature on the programmed cool after the first heat cycle with a peak of 198.9° C.; a T_{g} with an onset of 77.1° C., a midpoint of 79.8° C., and an endpoint of 82.1° C.; and a Tₘ observed to be at 253.4° C. (38.8 J/g).

### Example 10

To a 250 mL glass flask was added 178.00 gm bis(2-hydroxyethyl)terephthalate, 7.10 gm Nyglos® 8, 0.0617 gm manganese(II) acetate tetrahydrate, and 0.0505 gm antimony(III) trioxide. The reaction mixture was stirred and heated to 180° C. under a slow nitrogen purge. After achieving 180° C., the reaction mixture was stirred at 180° C. for 0.5 hours while under a slow nitrogen purge. The reaction mixture was then stirred under a slow nitrogen purge while being heated over 0.2 hours to 225° C. After achieving 225° C., the reaction mixture was stirred at 225° C. for 0.6 hours while under a slow nitrogen purge. The reaction mixture was again stirred under a slow nitrogen purge while being heated over 0.3 hours to 285° C. After reaching 285° C., the reaction mixture was stirred at 285° C. for 1.1 hours while under a slight nitrogen purge. During the heating cycle, 25.4 gm of colorless distillate was collected. The reaction mixture was then staged to full vacuum with stirring at 285° C. The resulting reaction mixture was stirred for 1.9 hours under full vacuum (pressure less than 100 mtorr). The vacuum was released with nitrogen and the reaction mass was allowed to cool to room temperature. 111.3 gm of a solid product, as well as, an additional 15.7 gm of distillate were recovered.

The solid product was found to have an LRV of 26.86 and a calculated IV of 0.73 dL/g. DSC analysis revealed a recrystallization temperature on the programmed cool after the first heat cycle with an onset of 205.9° C. and a peak of 198.2° C. (38.2 J/g); a T_{g} with an onset of 76.5° C., a midpoint of 81.0° C., and an endpoint of 85.5° C.; and a Tₘ observed to be at 247.9° C. (36.4 J/g).

### Example 11

To a 250 mL glass flask was added 106.93 gm bis(2-hydroxyethyl)terephthalate, 14.25 gm poly(ethylene glycol) (average molecular weight of 1500), 5.00 gm Nyglos® 4, 0.0446 gm manganese(II) acetate tetrahydrate, and 0.0359 gm antimony(III) trioxide. The reaction mixture was stirred and heated to 180° C. under a slow nitrogen purge. After achieving 180° C., the resulting reaction mixture was stirred at 180° C. for 0.6 hours while under a slow nitrogen purge. The reaction mixture was then stirred under a slow nitrogen purge while being heated over 0.6 hours to 225° C. After achieving 225° C., the reaction mixture was stirred at 225° C. for 0.6 hours while under a slow nitrogen purge. The reaction mixture was again stirred under a slow nitrogen purge while being heated over 1.0 hour to 295° C. After reaching 295° C., the reaction mixture was stirred at 295° C. for 0.6 hours while under a slight nitrogen purge. During the heating cycle, 16.3 gm of colorless distillate was collected. The reaction mixture was then staged to full vacuum with stirring at 295° C. The resulting reaction mixture was stirred for 3.0 hours under full vacuum (pressure less than 100 mtorr). The vacuum was released with nitrogen, and the reaction mass was allowed to cool to room temperature. 93.7 gm of solid product, as well as, an additional 10.7 gm of distillate were recovered.

The solid product was found to have an LRV of 26.33 and a calculated IV of 0.72 dL/g. DSC analysis revealed a recrystallization temperature on the programmed cool after the first heat cycle with an onset at 199.3° C. and a peak at 192.5° C. (J/g); and a Tₘ observed to be at 239.9° C. (35.2 J/g).

### Example 12

To a 250 mL glass flask was added 120.50 gm bis(2-hydroxyethyl)terephthalate, 5.00 gm Nyglos® 4, 50.00 gm of Aquablak® 6071 by the Solutions Dispersion Company (Aquablak® 6071 is a ball milled dispersion of 8.00 weight percent Ketjinblack® EC 300 J carbon black and 0.7 weight percent polyvinylpyrrolidone in ethylene glycol), 0.0446 gm manganese(II) acetate tetrahydrate, and 0.0359 gm antimony(III) trioxide. The reaction mixture was stirred and heated to 180° C. under a slow nitrogen purge. After achieving 180° C., the reaction mixture was stirred at 180° C. for 0.5 hours while under a slow nitrogen purge. The reaction mixture was then stirred under a slow nitrogen purge while being heated over 0.5 hours to 225° C. After achieving 225° C., the reaction mixture was stirred at 225° C. for 0.6 hours while under a slow nitrogen purge. The reaction mixture was again stirred under a slow nitrogen purge while being heated over 0.9 hours to 295° C. After obtaining 295° C., the reaction mixture was stirred at 295° C. for 0.5 hours while under a slight nitrogen purge. During the heating cycle, 65.8 gm of colorless distillate was collected. The reaction mixture was then staged to full vacuum with stirring at 295° C. The resulting reaction mixture was stirred for 1.7 hours under full vacuum (pressure less than 100 mtorr). The vacuum was released with nitrogen, and the reaction mass was allowed to cool to room temperature. 111.3 gm of a solid product, as well as, an additional 10.2 gm of distillate were recovered.

The solid product was found to have an LRV of 18.85 and a calculated IV of 0.59 dL/g. DSC analysis revealed a recrystallization temperature on the programmed cool after the first heat cycle with an onset of 206.8° C. and a peak of 200.4° C. (37.1 J/g); and a Tₘ observed to be at 245.4° C. (35.2 J/g).

The surface resistivity was found to be 2.62×10⁴ Ohms per square.

### Example 13

To a 250 mL glass flask was added 116.51 gm dimethyl terephthalate, 73.06 gm 1,3-propanediol, 6.51 gm Nyglos® MFH18, 0.0551 gm manganese(II) acetate tetrahydrate, and 0.0444 gm antimony(III) trioxide. The reaction mixture was stirred and heated to 180° C. under a slow nitrogen purge. After achieving 180° C., the reaction mixture was stirred at 180° C. for 0.5 hours while under a slow nitrogen purge. The reaction mixture was stirred under a slow nitrogen purge while being heated over 0.3 hours to 190° C. After achieving 190° C., the reaction mixture was stirred at 190° C. for 0.5 hours while under a slow nitrogen purge. The reaction mixture was again stirred under a slow nitrogen purge while being heated over 0.2 hours to 200° C. After achieving 200° C., the resulting reaction mixture was stirred at 200° C. for 0.5 hours while under a slow nitrogen purge. The reaction mixture was again stirred under a slow nitrogen purge while being heated over 0.5 hours to 250° C. After achieving 225° C., the reaction mixture was stirred at 225° C. for 0.5 hours while under a slow nitrogen purge. The reaction mixture was again stirred under a slow nitrogen purge while being heated over 0.4 hours to 255° C. After obtaining 255° C., the reaction mixture was stirred at 255° C. for 0.7 hours while under a slight nitrogen purge. During the heating cycle, 33.3 gm of colorless distillate was collected. The reaction mixture was then staged to full vacuum with stirring at 255° C. The resulting reaction mixture was stirred for 2.1 hours under full vacuum (pressure less than 100 mtorr). The vacuum was released with nitrogen, and the reaction mass was allowed to cool to room temperature. 107.9 gm of a solid product, as well as, an additional 20.5 gm of distillate were recovered.

The solid product was found to have an LRV of 7.80 and a calculated IV of 0.39 dL/g. DSC analysis revealed a recrystallization temperature on the programmed cool after the first heat cycle with an onset of 171.1° C. and a peak of 158.6° C. (63.4 J/g); a T_{g} with an onset of 47.2° C., a midpoint of 49.6° C., and an endpoint of 52.1° C.; and a Tₘ observed to be at 226.8° C. (55.8 J/g).

### Example 14

To a 250 mL glass flask was added 56.44 gm dimethyl terephthalate, 37.62 gm dimethyl isophthalate, 60.13 gm ethylene glycol, 7.00 grams Nyglos® 4, 0.0446 gm manganese(II) acetate tetrahydrate, and 0.0359 gm antimony(III) trioxide. The reaction mixture was stirred and heated to 180° C. under a slow nitrogen purge. After achieving 180° C., the reaction mixture was stirred at 180° C. for 0.5 hours while under a slow nitrogen purge. The reaction mixture was then stirred under a slow nitrogen purge while being heated over 0.3 hours to 190° C. After achieving 190° C., the reaction mixture was stirred at 190° C. for 0.5 hours while under a slow nitrogen purge. The reaction mixture was again stirred under a slow nitrogen purge while being heated over 0.2 hours to 200° C. After achieving 200° C., the resulting reaction mixture was stirred at 200° C. for 0.5 hours while under a slow nitrogen purge. The reaction mixture was again stirred under a slow nitrogen purge while being heated over 0.2 hours to 225° C. After achieving 225° C., the reaction mixture was stirred at 225° C. for 0.5 hours while under a slow nitrogen purge. The reaction mixture was again stirred under a slow nitrogen purge while being heated over 0.7 hours to 295° C. The reaction mixture was stirred at 295° C. for 0.5 hours while under a slight nitrogen purge. During the heating cycle, 42.0 gm of colorless distillate was collected. The reaction mixture was then staged to full vacuum with stirring at 295° C. The resulting reaction mixture was stirred for 2.9 hours under full vacuum (pressure less than 100 mtorr). The vacuum was released with nitrogen, and the reaction mass was allowed to cool to room temperature. 100.9 gm of a solid product, as well as, an additional 10.9 gm of distillate were recovered.

The solid product was found to have an LRV of 24.29 and a calculated IV of 0.69 dL/g. DSC analysis revealed a T_{g} with an onset of 68.1° C., a midpoint of 69.9° C., and an endpoint of 72.0° C.; and no observed Tₘ.

### Example 15

To a 250 mL glass flask was added 40.00 gm dimethyl terephthalate, 24.82 gm 1,4-butanediol, 45.29 gm poly(tetramethylene ether)glycol (average molecular weight of 1400), 7.39 gm Nyglos® 4, and 0.088 gm titanium(IV) isopropoxide. The reaction mixture was stirred and heated to 180° C. under a slow nitrogen purge. After achieving 180° C., the reaction mixture was stirred at 180° C. for 0.5 hours while under a slow nitrogen purge. The reaction mixture was then stirred under a slow nitrogen purge while being heated over 0.2 hours to 190° C. After achieving 190° C., the reaction mixture was stirred at 190° C. for 0.5 hours while under a slow nitrogen purge. The reaction mixture was again stirred under a slow nitrogen purge while being heated over 0.1 hours to 200° C. After achieving 200° C., the reaction mixture was stirred at 200° C. for 0.5 hours while under a slow nitrogen purge. The reaction mixture was again stirred under a slow nitrogen purge while being heated over 0.3 hours to 225° C. After achieving 225° C., the reaction mixture was stirred at 225° C. for 0.8 hours while under a slow nitrogen purge. The reaction mixture was again stirred under a slow nitrogen purge while being heated over 0.5 hours to 255° C. After obtaining 255° C., the reaction mixture was stirred at 255° C. for 1.0 hour while under a slight nitrogen purge. During the heating cycle, 7.0 gm of colorless distillate was collected. The reaction mixture was then staged to full vacuum with stirring at 255° C. The resulting reaction mixture was stirred for 1.5 hours under full vacuum (pressure less than 100 mtorr). The vacuum was released with nitrogen, and the reaction mass was allowed to cool to room temperature. 71.6 gm of solid product, as well as, an additional 2.1 gm of distillate were recovered.

The solid product was found to have an LRV of 44.16 and a calculated IV of 1.05 dL/g. DSC analysis revealed a recrystallization temperature on the programmed cool after the first heat cycle with an onset of 180.0° C. and a peak of 169.6° C. (22.6 J/g); and a Tₘ observed to be at 197.8° C. (19.9 J/g).

### Example 16

To a 250 mL glass flask was added 177.97 gm bis(2-hydroxyethyl)terephthalate, 14.93 gm Nyglos® 4, 0.0597 gm manganese(II) acetate tetrahydrate, and 0.0493 gm antimony(III) trioxide. The reaction mixture was stirred and heated to 190° C. under a slow nitrogen purge. After achieving 190° C., the reaction mixture was stirred at 190° C. for 0.1 hours while under a slow nitrogen purge. The reaction mixture was then stirred under a slow nitrogen purge while being heated over 0.2 hours to 225° C. After achieving 225° C., the reaction mixture was stirred at 225° C. for 0.8 hours while under a slow nitrogen purge. The reaction mixture was again stirred under a slow nitrogen purge while being heated over 0.5 hours to 285° C. After reaching 285° C., the reaction mixture was stirred at 285° C. for 0.8 hours while under a slight nitrogen purge. During the heating cycle, 25.8 gm of colorless distillate was collected. The reaction mixture was then staged to full vacuum with stirring at 285° C. The resulting reaction mixture was stirred for 1.2 hours under full vacuum (pressure less than 100 mtorr). The vacuum was released with nitrogen, and the reaction mass was allowed to cool to room temperature. 143.0 gm of a solid product, as well as, an additional 15.1 gm of distillate were recovered.

The solid product was found to have an LRV of 16.42 and a calculated IV of 0.54 dL/g. DSC analysis revealed a recrystallization temperature on the programmed cool after the first heat cycle with an onset of 214.2° C. and a peak of 208.7° C. (42.3 J/g); a T_{g} with an onset of 73.3° C., a midpoint of 80.0° C., and an endpoint of 86.5° C.; and a Tₘ observed to be at 255.2° C. (40.2 J/g).

### Example 17

To a 250 mL glass flask was added 116.51 gm dimethyl terephthalate, 73.06 gm 1,3-propanediol, 13.73 gm Nyglos® 4, 0.0561 gm manganese(II) acetate tetrahydrate, and 0.0440 gm antimony(III) trioxide. The mixture was stirred and heated to 200° C. under a slow nitrogen purge. After achieving 200° C., the resulting reaction mixture was stirred at 200° C. for 0.7 hours while under a slow nitrogen purge. The reaction mixture was then stirred under a slow nitrogen purge while being heated over 0.3 hours to 225° C. After achieving 225° C., the reaction mixture was stirred at 225° C. for 0.6 hours while under a slow nitrogen purge. The reaction mixture was again stirred under a slow nitrogen purge while being heated over 0.4 hours to 255° C. After reaching 255° C., the reaction mixture was stirred at 255° C. for 0.8 hours while under a slight nitrogen purge. During the heating cycle, 30.2 gm of colorless distillate was collected. The reaction mixture was then staged to full vacuum with stirring at 255° C. The resulting reaction mixture was stirred for 4.7 hours under full vacuum (pressure less than 100 mtorr). The vacuum was released with nitrogen, and the reaction mass was allowed to cool to room temperature. 121.0 gm of solid product, as well as, an additional 15.5 gm of distillate were recovered.

The solid product was found to have an LRV of 23.73 and a calculated IV 0.68 dL/g. DSC analysis revealed a recrystallization temperature on the programmed cool after the first heat cycle with an onset of 179.6° C. and a peak of 173.6° C. (45.7 J/g); a T_{g} with an onset of 48.4° C., a midpoint of 54.3° C., and an endpoint of 60.1° C.; and a Tₘ observed to be at 231.8° C. (45.6 J/g).

### Example 18

To a 250 mL glass flask was added 177.97 gm bis(2-hydroxyethyl)terephthalate, 23.72 gm Nyglos® 4, 0.0613 gm manganese(II) acetate tetrahydrate, and 0.0490 gm antimony(III) trioxide. The reaction mixture was stirred and heated to 190° C. under a slow nitrogen purge. After achieving 190° C., the reaction mixture was stirred at 190° C. for 0.1 hours while under a slow nitrogen purge. The reaction mixture was then stirred under a slow nitrogen purge while being heated over 0.4 hours to 225° C. After achieving 225° C., the reaction mixture was stirred at 225° C. for 0.7 hours while under a slow nitrogen purge. The reaction mixture was again stirred under a slow nitrogen purge while being heated over 0.4 hours to 285° C. After achieving 285° C., the reaction mixture was stirred at 285° C. for 1.1 hours while under a slight nitrogen purge. During the heating cycle, 27.2 gm of colorless distillate was collected. The reaction mixture was then staged to full vacuum with stirring at 285° C. The resulting reaction mixture was stirred for 0.5 hours under full vacuum (pressure less than 100 mtorr). The vacuum was released with nitrogen, and the reaction mass was allowed to cool to room temperature. 143.0 gm of a solid product, as well as, an additional 15.2 gm of distillate were recovered.

The solid product was found to have an LRV of 12.15 and a calculated IV of 0.47 dL/g. DSC analysis revealed a recrystallization temperature on programmed cool after the first heat cycle with an onset of 216.6° C. and a peak of 212.0° C. (40.6 J/g); a T_{g} with an onset of 71.2° C., a midpoint of 78.9° C., and an endpoint of 86.7° C.; and a Tₘ observed to be at 256.3° C. (39.4 J/g).

### Example 19

To a 250 mL glass flask was added 177.97 gm bis(2-hydroxyethyl)terephthalate, 33.60 gm Nyglos® 4, 0.0598 gm manganese(II) acetate tetrahydrate, and 0.0478 gm antimony(III) trioxide. The reaction mixture was stirred and heated to 190° C. under a slow nitrogen purge. After achieving 190° C., the reaction mixture was stirred at 190° C. for 0.5 hours while under a slow nitrogen purge. The reaction mixture was then stirred under a slow nitrogen purge while being heated over 0.4 hours to 225° C. After achieving 225° C., the reaction mixture was stirred at 225° C. for 0.8 hours while under a slow nitrogen purge. The reaction mixture was again stirred under a slow nitrogen purge while being heated over 0.4 hours to 285° C. After achieving 285° C., the reaction mixture was stirred at 285° C. for 1.1 hours under a slight nitrogen purge. During the heating cycle, 22.1 gm of colorless distillate was collected. The reaction mixture was then staged to full vacuum with stirring at 285° C. The resulting reaction mixture was stirred for 1.0 hour under full vacuum (pressure less than 100 mtorr). The vacuum was released with nitrogen and the reaction mass was allowed to cool to room temperature. 140.0 gm of solid product, as well as, an additional 18.2 gm of distillate were recovered.

The solid product was found to have an LRV of 11.72 and a calculated IV of 0.46 dL/g. DSC analysis revealed a recrystallization temperature on the programmed cool after the first heat cycle with an onset of 216.9° C. and a peak of 212.9° C. (37.0 J/g); a T_{g} with an onset of 66.9° C., a midpoint of 77.2° C., and an endpoint of 87.5° C.; and a Tₘ observed to be at 255.0° C. (33.5 J/g).

### Example 20

To a 250 mL glass flask was added 116.51 gm dimethyl terephthalate, 73.06 gm 1,3-propanediol, 30.90 gm Nyglos® 4, 0.0551 gm manganese(II) acetate tetrahydrate, and 0.0444 gm antimony(III) trioxide. The reaction mixture was stirred and heated to 180° C. under a slow nitrogen purge. After achieving 180° C., the resulting reaction mixture was stirred at 180° C. for 0.5 hours while under a slow nitrogen purge. The reaction mixture was then stirred under a slow nitrogen purge while being heated over 0.2 hours to 190° C. After achieving 190° C., the reaction mixture was stirred at 190° C. for 0.5 hours while under a slow nitrogen purge. The reaction mixture was again stirred under a slow nitrogen purge while being heated over 0.3 hours to 200° C. After achieving 200° C., the resulting reaction mixture was stirred at 200° C. for 0.5 hours while under a slow nitrogen purge. The reaction mixture was again stirred under a slow nitrogen purge while being heated over 0.4 hours to 225° C. After achieving 225° C., the reaction mixture was stirred at 225° C. for 0.5 hours while under a slow nitrogen purge. The reaction mixture was again stirred under a slow nitrogen purge while being heated over 0.2 hours to 255° C. After reaching 255° C., the reaction mixture was stirred at 255° C. for 0.3 hours under a slight nitrogen purge. During the heating cycle, 34.3 gm of colorless distillate was collected. The reaction mixture was then staged to full vacuum with stirring at 255° C. The resulting reaction mixture was stirred for 3.6 hours under full vacuum (pressure less than 100 mtorr). The vacuum was then released with nitrogen, and the reaction mass was allowed to cool to room temperature. 143.1 gm of solid product, as well as, an additional 21.1 gm of distillate were recovered.

The solid product was found to have an LRV of 9.81 and a calculated IV of 0.42 dL/g. DSC analysis revealed a recrystallization temperature on the programmed cool after the first heat cycle with an onset of 184.6° C. and a peak of 178.5° C. (51.6 J/g); and a Tₘ observed to be at 228.6° C. (45.8 J/g).

### Example 21

To a 1 liter glass flask was added 699.16 gm bis(2-hydroxyethyl)terephthalate, 226.29 gm Nyglos® 4, 0.3365 gm manganese(II) acetate tetrahydrate, and 0.2709 gm antimony(III) trioxide. The reaction mixture was stirred and heated to 180° C. under a slow nitrogen purge. After achieving 180° C., the reaction mixture was stirred at 180° C. for 0.3 hours while under a slow nitrogen purge. The reaction mixture was then stirred under a slow nitrogen purge while being heated over 1.0 hour to 225° C. After achieving 225° C., the reaction mixture was stirred at 225° C. for 0.6 hours while under a slow nitrogen purge. The reaction mixture was again stirred under a slow nitrogen purge while being heated over 0.7 hours to 285° C. After reaching 285° C., the reaction mixture was stirred at 285° C. for 0.9 hours under a slight nitrogen purge. During the heating cycle, 88.4 gm of colorless distillate was collected. The reaction mixture was then staged to full vacuum with stirring at 285° C. The resulting reaction mixture was stirred for 3.4 hours under full vacuum (pressure less than 100 mtorr). The vacuum was then released with nitrogen, and the reaction mass was allowed to cool to room temperature. 724.1 gm of a solid product, as well as, an additional 71.1 gm of distillate were recovered.

The solid product was found to have an LRV of 6.54 and a calculated IV of 0.36 dL/g. DSC analysis revealed a recrystallization temperature on the programmed cool after the first heat cycle with an onset of 223.2° C. and a peak of 219.4° C. (42.9 J/g); a T_{g} with an onset of 67.6° C., a midpoint of 68.8° C., and an endpoint of 69.9° C.; and a Tₘ observed to be at 257.3° C. (43.9 J/g).

### Example 22

A nominal 100 lb vertical autoclave with an agitator, vacuum pump, and condenser located above the pressure vessel was used to prepare batches of polymer containing approximately 5 wt % Wollastonite. The pressure vessel was charged with approximately 72 lbs dimethyl terephthalate, and approximately 3.8 lbs Vansil® H325 Wollastonite in 7.5 lbs ethylene glycol was added. Additional ethylene glycol was added to the autoclave to bring the total amount added to about 46 lbs. Manganese acetate was used as the ester exchange catalyst, and antimony trioxide was used as the polycondensation catalyst. The reactor was heated to approximately 240° C. over a period of about 400 minutes. An estimated 31.5 lbs of methanol+ethylene glycol distillate was recovered. The vessel was then converted to allow vacuum to be applied.

The ingredients were mixed, agitated, and polymerized by increasing the final temperature to approximately 285° C. The pressure was reduced to a final pressure of about 0.7 mm Hg over a period of about 150 minutes. The polymer was extruded through a 6 hole casting plate into strands that were quenched, cut, and boxed.

The polymer was found to have an IV of about 0.55.

### Example 23

A nominal 100 lb vertical autoclave with an agitator, vacuum pump, and a condenser located above the pressure vessel was used to prepare batches of polymer containing approximately 10 wt % Wollastonite. The vessel was charged with approximately 68 lbs of dimethyl terephthalate, and approximately 7.5 lbs of Vansil® H325 Wollastonite in 15 lbs of ethylene glycol was added. Additional ethylene glycol was added to the autoclave to bring the total amount added to about 44 lbs. Manganese acetate was used as the ester exchange catalyst, and antimony trioxide was used as the polycondensation catalyst. The reactor was heated to approximately 240° C. over a period of about 400 minutes. An estimated 33.3 lbs of methanol+ethylene glycol distillate was recovered. The vessel was then converted to allow vacuum to be applied.

The ingredients were mixed, agitated, and polymerized by increasing the final temperature to approximately 285° C. The pressure was reduced to a final pressure of about 0.8 mm Hg over a period of about 140 minutes. The polymer was extruded through a 6 hole casting plate into strands that were quenched, cut, and boxed.

The polymer was found to have an IV of about 0.51.

What is claimed is:

1. A process for making a polyester comprising
a. providing a polyester composition comprising at least one diester based on terephthalic acid; at least one glycol; at least about 1 wt. % wollastonite, based on total weight of the polyester composition; optionally at least one other dicarboxylic acid; optionally at least one polyfunctional branching agent; and optionally at least one other filler;
b. adding the wollastonite at a temperature of about 240° C. or less;
c. contacting the wollastonite and optional other filler with at least one polymerizable component of the polyester composition; and
d. polymerizing the polymerizable components.

2. The process of claim 1, wherein the polyester composition comprises from about 1 to about 100 mole percent of the at least one diester based on terephthalic acid, based on 100 mole percent total diester based on terephthalic acid and optional other dicarboxylic acid.

3. The process of claim 1, wherein the polyester composition comprises from about 50 to about 100 mole percent of the at least one diester based on terephthalic acid, based on 100 mole percent total diester based on terephthalic acid and optional other dicarboxylic acid.

4. The process of claim 1, wherein the diester based on terephthalic acid is selected from dimethyl terephthalate; diethyl terephthalate; bis(2-hydroxyethyl)terephthalate; bis(3-hydroxypropyl)terephthalate; bis(4-hydroxybutyl)terephthalate; and mixtures thereof.

5. The process of claim 1, wherein the glycol is selected from ethylene glycol; 1,3-propanediol; 1,4-butanediol; 1,6-hexanediol; 1,8-octanediol; 1,10-decanediol; 1,12-dodecanediol; 1,14-tetradecanediol;1,16-hexadecanediol; dimer diol; 4,8-bis(hydroxymethyl)-tricyclo[5.2.1.0/2.6]decane; 1,4-cyclohexanedimethanol; isosorbide; di(ethylene glycol); tri(ethylene glycol); poly(alkylene ether)glycols preferably having a molecular weight in the range of from about 500 to about 4000; poly(ethylene glycol); poly(1,3-propylene glycol); poly(1,4-butylene glycol); (polytetrahydrofuran); poly(pentamethylene glycol); poly(hexamethylene glycol); poly(hepthamethylene glycol); poly(ethylene glycol)-block-poly(propylene glycol)-block-poly(ethylene glycol); 4,4′-isopropylidenediphenol ethoxylate (Bisphenol A ethoxylate); 4,4′-(1-phenylethylidene)bisphenol ethoxylate (Bisphenol AP ethoxylate); 4,4′-ethylidenebisphenol ethoxylate (Bisphenol E ethoxylate); bis(4-hydroxyphenyl)methane ethoxylate (Bisphenol F ethoxylate); 4,4′-(1,3-phenylenediisopropylidene)bisphenol ethoxylate (Bisphenol M ethoxylate); 4,4′-(1,4-phenylenediisopropylidene)bisphenol ethoxylate (Bisphenol P ethoxylate); 4,4′sulfonyidiphenol ethoxylate (Bisphenol S ethoxylate); 4,4′-cyclohexylidenebisphenol ethoxylate (Bisphenol Z ethoxylate); and mixtures thereof.

6. The process of claim 1, wherein the polyester composition comprises from about 1 to about 30 wt. % wollastonite.

7. The process of claim 1, wherein the polyester composition comprises from about 2.5 to about 20 wt. % wollastonite.

8. The process of claim 1, wherein the wollastonite comprises acicular calcium silicate.

9. The process of claim 1, wherein the wollastonite has an aspect ratio of at least about 5:1.

10. The process of claim 1, wherein the wollastonite has an aspect ratio of at least about 10:1.

11. The process of claim 1, wherein the wollastonite has a median particle diameter of about 20 microns or less.

12. The process of claim 1, wherein the wollastonite has a median particle diameter of about 10 microns or less.

13. The process of claim 1, wherein the wollastonite has a median particle diameter of about 3 microns to about 10 microns.

14. The process of claim 1, wherein the wollastonite is added at a temperature of about 230° C. or less.

15. The process of claim 1, wherein the polyester composition comprises from about 0 to about 99 mole percent optional other dicarboxylic acid, based on 100 mole percent total diester based on terephthalic acid and optional other dicarboxylic acid.

16. The process of claim 1, wherein the polyester composition comprises from about 0 to about 50 mole percent optional other dicarboxylic acid, based on 100 mole percent total diester based on terephthalic acid and optional other dicarboxylic acid.

17. The process of claim 1, wherein the optional at least one other dicarboxylic acid is selected from isophthalic acid; dimethyl isophthalate; 2,6-naphthalene dicarboxylic acid; dimethyl-2,6-naphthalate; 2,7-naphthalene dicarboxylic acid; dimethyl-2,7-naphthalate; metal salts of 5-sulfoisophthalic acid; sodium dimethyl-5-sulfoisophthalate; lithium dimethyl-5-sulfoisophthalate; 3,4′-diphenyl ether dicarboxylic acid; dimethyl-3,4′diphenyl ether dicarboxylate; 4,4′-diphenyl ether dicarboxylic acid; dimethyl-4,4′-diphenyl ether dicarboxylate; 3,4′-diphenyl sulfide dicarboxylic acid; dimethyl-3,4′-diphenyl sulfide dicarboxylate; 4,4′-diphenyl sulfide dicarboxylic acid; dimethyl-4,4′-diphenyl sulfide dicarboxylate; 3,4′-diphenyl sulfone dicarboxylic acid; dimethyl-3,4′-diphenyl sulfone dicarboxylate; 4,4′-diphenyl sulfone dicarboxylic acid; dimethyl-4,4′-diphenyl sulfone dicarboxylate; 3,4′-benzophenonedicarboxylic acid; dimethyl-3,4′-benzophenonedicarboxylate; 4,4′-benzophenonedicarboxylic acid; dimethyl-4,4′-benzophenonedicarboxylate; 1,4-naphthalene dicarboxylic acid; dimethyl-1,4-naphthalate; 4,4′-methylene bis(benzoic acid); dimethyl-4,4′-methylenebis(benzoate); bis(2-hydroxyethyl)isophthalate; bis(3-hydroxypropyl)isophthalate; bis(4-hydroxybutyl)isophthalate; oxalic acid; dimethyl oxalate; malonic acid; dimethyl malonate; succinic acid; dimethyl succinate; methylsuccinc acid; glutaric acid; dimethyl glutarate; 2-methylglutaric acid; 3-methylglutaric acid; adipic acid; dimethyl adipate; 3-methyladipic acid; 2,2,5,5-tetramethylhexanedioic acid; pimelic acid; suberic acid; azelaic acid; dimethyl azelate; sebacic acid; 1,11-undecanedicarboxylic acid; 1,10-decanedicarboxylic acid; undecaned ioic acid; 1,12-dodecanedicarboxylic acid; hexadecanedioic acid; docosanedioic acid; tetracosanedioic acid; dimer acid; bis(2-hydroxyethyl)glutarate; bis(3-hydroxypropyl)glutarate; bis(4-hydroxybutyl)glutarate); and mixtures thereof.

18. The process of claim 1, wherein the polyester composition comprises from 0 to about 1.0 mole percent polyfunctional branching agent, based on 100 mole percent total diester based on terephthalic acid and optional other dicarboxylic acid.

19. The process of claim 1, wherein the polyfunctional branching agent is selected from 1,2,4-benzenetricarboxylic acid (trimellitic acid); trimethyl-1,2,4-benzenetricarboxylate; 1,2,4-benzenetricarboxylic anhydride (trimellitic anhydride); 1,3,5-benzenetricarboxylic acid; 1,2,4,5-benzenetetracarboxylic acid (pyromellitic acid); 1,2,4,5-benzenetetracarboxylic dianhydride (pyromellitic anhydride); 3,3′,4,4′-benzophenonetetracarboxylic dianhydride; 1,4,5,8-naphthalenetetracarboxylic dianhydride; citric acid; tetrahydrofuran-2,3,4,5-tetracarboxylic acid; 1,3,5-cyclohexanetricarboxylic acid; pentaerythritol; glycerol; 2-(hydroxymethyl)-1,3-propanediol; 2,2-bis(hydroxymethyl)propionic acid; and mixtures thereof.

20. The process of claim 1, wherein the polyester composition contains at least about 0.01 wt. % of the optional other filler, based on total weight of the polyester composition.

21. The process of claim 1, wherein the polyester composition contains from about 0.1 to about 20 wt. % of the optional other filler, based on total weight of the polyester composition.

22. The process of claim 1, wherein the polyester composition contains from about 1 to about 15 wt. % of the optional other filler, based on total weight of the polyester composition.

23. The process of claim 1, wherein the optional other filler is carbon black.

24. The process of claim 23, wherein the carbon black has a DBP absorption value of at least about 150 cc/100 grams.

25. The process of claim 23, wherein the carbon black has a DBP absorption value of at least about 220 cc/100 grams.

26. The process of claim 23, wherein the polyester composition contains about 15 wt. % or less carbon black, based on total weight of the polyester composition.

27. The process of claim 23, wherein the polyester composition contains from about 0.5 to about 10 wt. % carbon black, based on total weight of the polyester composition.

28. The process of claim 23, wherein the polyester composition contains from about 1.0 to about 7 wt. % carbon black, based on total weight of the polyester composition.

29. The process of claim 1, wherein the polymerizable components are polymerized at a temperature of about 200° to 330° C.

30. The process of claim 1, wherein the polymerizable components are polymerized at a temperature of 220° to 295° C.

31. A polyester produced in accordance with the process of claim 1, wherein said polyester has an inherent viscosity of at least about 0.25 dL/g, as measured on a 0.5% solution of the polyester in a 50:50 solution of trifluoroacetic acid:dichloromethane solvent system at room temperature.

32. The polyester of claim 31, wherein the inherent viscosity is at least about 0.35 dL/g.

33. The polyester of claim 31, wherein the inherent viscosity is at least about 0.50 dL/g.

34. The process of claim 1, wherein the optional other filler comprises a first set of particles having a first average particle size, and a second set of particles having a second average particle size, wherein the second average particle size is at least about 2 times greater that the first average particle size.

35. The process of claim 1, wherein the optional other filler comprises particles having an average diameter less than about 40 microns.

36. The process of claim 1, wherein the optional other filler comprises particles having an average diameter less than about 20 microns.

37. A blend comprising the polyester of claim 1 and at least one other polymeric material.

38. The blend of claim 37, wherein the other polymeric material is a natural polymeric material.

39. The blend on claim 38, wherein the natural polymeric material is a starch.

40. A shape article formed from the polyesters of claim 1.

41. The shaped article of claim 40, wherein the shaped article is selected from films, sheets, fibers, monofilaments, nonwoven structures, melt blown containers, molded parts, and foamed parts.

42. A shaped article formed from the polyester of claim 23.

43. The shaped article of claim 42, wherein the shaped article is selected from films, sheets, fibers, monofilaments, nonwoven structures, melt blown containers, molded parts, and foamed parts

44. A film comprising the polyester of claim 1.

45. The film of claim 44, having a thickness from about 0.025 mm to about 0.15 mm.

46. An oriented film according to claim 44.

47. The film of claim 46, wherein the film is biaxially oriented.

48. The film of claim 46, wherein the film is uniaxially oriented.

49. A film comprising the polyester of claim 23.

50. The film of claim 49, having a thickness from about 0.025 mm to about 0.15 mm.

51. An oriented film according to claim 49.

52. The film of claim 51, wherein the film is biaxially oriented.

53. The film of claim 51, wherein the film is uniaxially oriented.

54. A multilayer film comprising a layer comprising the polyester of claim 1.

55. An article comprising a substrate and a coating on the substrate, the coating comprising the polyester of claim 1.

56. The article of claim 55, wherein the coating has a thickness from about 0.2 to about 15 mils.

57. The article of claim 55, wherein the coating has a thickness from about 0.5 to about 2 mils.

58. The article of claim 55 wherein the substrate is selected from textiles, nonwovens, foil, paper, paperboard, and metals.

59. An article comprising a substrate having laminated thereon the polyester of claim 1.

60. The article of claim 59, wherein the substrate is selected from paper, paperboard, cardboard, fiberboard, cellulose, starch, plastic, polystyrene foam, glass, metal, metal foil, polymeric foam, organic foam, inorganic foam, organic-inorganic foam, and polymeric film.

61. A sheet comprising the polyester of claim 1.

62. The sheet of claim 61, having a thickness of at least about 0.50 mm.

63. A sheet comprising the polyester of claim 23.

64. The sheet of claim 63, having a thickness of at least about 0.50 mm.

65. A fiber comprising the polyester of claim 1.

66. The fiber of claim 65 having a denier from about 0.1 to about 100.

67. The fiber of claim 65 having a denier from about 0.5 to about 20.

68. The fiber of claim 65, wherein the fiber is heterogeneous.

69. A fiber comprising the polyester of claim 23.

70. The fiber of claim 69 having a denier from about 0.1 to about 100.

71. The fiber of claim 69 having a denier from about 0.5 to about 20.

72. The fiber of claim 69, wherein the fiber is heterogeneous.

73. A fiber blend comprising the polyester of claim 1 and at least one other fiber.

74. The fiber blend of claim 73, wherein the other fiber is a natural fiber.

75. A fiber comprising the polyester of claim 1 and at least one other polymer selected from a synthetic polymer and a natural polymer.

76. A monofilament comprising the polyester of claim 1.

77. A monofilament comprising the polyester of claim 23.

78. A foamed article comprising the polyester of claim 1.

79. A shaped article formed from the blend of claim 37.

80. The shaped article of claim 79, selected from films, sheets, fibers, melt blown containers, molded parts, and foamed parts.

81. A film comprising the blend of claim 37.

82. The film of claim 81, having a thickness from about 0.025 mm to about 0.15 mm.

83. An oriented film according to claim 81.

84. A foamed article comprising the blend of claim 37.

85. A multilayer film comprising a layer comprising a blend of claim 37.

86. An article comprising a substrate and a coating on the substrate, the coating comprising a blend of claim 37.

87. An article comprising a substrate having laminated thereon a blend of claim 37.

88. A sheet comprising the blend of claim 37.

89. A process for producing a package, comprising
i) providing a substrate;
ii) forming the substrate into a desired package form;
iii) providing a polyester comprising a polyester composition comprising at least one diester based on terephthalic acid; at least one glycol; at least about 1 wt. % wollastonite, based on total weight of the polyester composition; optionally at least one other dicarboxylic acid; optionally at least one polyfunctional branching agent; and optionally at least one other filler; wherein the wollastonite and optional other filler are contacted with at least one polymerizable component of the polyester composition; wherein the polymerizable components are polymerized at a temperature of about 240° C. or less; and
iv) laminating or coating the substrate with the polyester to form a package.

90. The process of claim 89, wherein the substrate comprises a material selected from paper, paperboard, inorganic foams, organic foams, and inorganic-organic foams.

91. The process of claim 89, wherein the package has a form selected from bags, cups, trays, cartons, boxes, bottles, crates, packaging films, blister pack wrappers, skin packaging, and hinged containers.
